(19) United States
(12) Patent Application Publication
(10) Pub. No.: US 2023/0096457 A1
(43) Pub. Date: Mar. 30, 2023

(54) DATA SYNCHRONIZATION METHOD, APPARATUS, AND DEVICE, AND COMPUTER READABLE STORAGE MEDIUM

(71) Applicant: Tencent Technology (Shenzhen) Company Limited, Shenzhen (CN)

(72) Inventors: Zongyou WANG, Shenzhen (CN); Hu Lan, Shenzhen (CN); Yifang SHI, Shenzhen (CN); Jinsong ZHANG, Shenzhen (CN)

(21) Appl. No.: 18/073,520

(22) Filed: Dec. 1, 2022

Related U.S. Application Data
(63) Continuation of application No. PCT/CN2021/131168, filed on Nov. 17, 2021.

(30) Foreign Application Priority Data
Dec. 24, 2020 (CN) 202011544970.X

(51) Int. Cl. G06F 16/27; H04L 9/00

(52) U.S. Cl. CPC G06F 16/275; H04L 9/50

(57) ABSTRACT

A data synchronization method includes: receiving a data synchronization request from a light node; the request including a block identifier; obtaining synchronization transaction data in the synchronization block according to the block identifier; the synchronization transaction data including transaction detail data and contract information; obtaining, from a database, a target data set corresponding to the synchronization transaction data; the target data set including read data or result data. The result data is obtained by processing the transaction detail data based on the contract information; and obtaining verification data corresponding to the synchronization transaction data, and transmitting the synchronization transaction data, the verification data, and the target data set to the light node; verifying by the light node, a validity of the synchronization transaction data and to-be-verified result data corresponding to the transaction detail data, based on the verification data and the target data set.

### CROSS-REFERENCE TO RELATED APPLICATIONS

This application is a continuation application of PCT Patent Application No. PCT/CN2021/131168, entitled “DATA SYNCHRONIZATION METHOD AND APPARATUS, AND DEVICE AND COMPUTER-READABLE STORAGE MEDIUM” filed on Nov. 17, 2021, which claims priority to Chinese Patent Application No. 202011544970.X, filed with the State Intellectual Property Office of the People's Republic of China on Dec. 24, 2020, and entitled “DATA SYNCHRONIZATION METHOD, APPARATUS, AND DEVICE, AND COMPUTER READABLE STORAGE MEDIUM”, all of which are incorporated herein by reference in their entirety.

### FIELD OF THE TECHNOLOGY

This application relates to the field of Internet technologies, and in particular, to a data synchronization method, apparatus, and device, and a computer readable storage medium.

### BACKGROUND OF THE DISCLOSURE

With rapid development of network technologies and attention to data security, a blockchain is greatly valued and applied.

The blockchain includes a full node and a light node, where the full node has full data and participates in accounting consensus, and the light node mainly performs service execution and does not participate in accounting consensus, but obtains block header data and partial authorized visible block data from a consensus network in an identity authentication manner. Therefore, the full node needs to broadcast, through a peer-to-peer (P2P) network layer, a block header of a new block that has reached consensus, so that the light node performs data synchronization on the new block.

In an existing data synchronization technology, for example, Ethereum and an enterprise operating system (EOS), the light node cannot self-check obtained data. If malicious behavior exists in a blockchain network, the light node cannot determine accuracy of the obtained data, and therefore, validity of synchronized data cannot be ensured.

### SUMMARY

Embodiments of this application provide a data synchronization method, apparatus, and device, and a computer readable storage medium, so as to accurately verify validity of data obtained through synchronization, so as to ensure validity of the synchronized data.

An aspect of the embodiments of this application provides a data synchronization method, performed by a computer device and including:

receiving a data synchronization request from a light node, the data synchronization request including a block identifier of a synchronization block requested by the light node;

obtaining synchronization transaction data in the synchronization block according to the block identifier, the synchronization transaction data including transaction detail data and contract information of a smart contract used for processing the transaction detail data;

obtaining, from a database, a target data set corresponding to the synchronization transaction data, the target data set including read data or result data, wherein the result data is obtained by processing the transaction detail data based on the contract information; and

obtaining, from the synchronization block, verification data corresponding to the synchronization transaction data;

transmitting the synchronization transaction data, the verification data, and the target data set to the light node; and

verifying, by the light node, a validity of the synchronization transaction data and to-be-verified result data corresponding to the transaction detail data, based on the verification data and the target data set.

An aspect of the embodiments of this application provides a data synchronization method, performed by a computer device and including:

transmitting a data synchronization request that includes a block identifier to a full node;

obtaining, by the full node, synchronization transaction data in a synchronization block according to the block identifier, a target data set corresponding to the synchronization transaction data from a database, and verification data corresponding to the synchronization transaction data from the synchronization block, wherein the block identifier represents an identifier of the requested synchronization block, the synchronization transaction data including transaction detail data and contract information of a smart contract used by the full node to process the transaction detail data, and the target data set including read data or result data, wherein the result data is obtained by processing the transaction detail data based on the contract information by the full node;

obtaining the synchronization transaction data, the verification data, and the target data set transmitted by the full node; and

verifying, according to the verification data and the target data set, a validity of the synchronization transaction data and to-be-verified result data corresponding to the transaction detail data.

An aspect of the embodiments of this application provides a data synchronization apparatus, including:

a first acquiring module, configured to acquire a data synchronization request transmitted by a light node, the data synchronization request including a block identifier of a synchronization block requested by the light node;

a second acquiring module, configured to acquire synchronization transaction data in the synchronization block according to the block identifier, the synchronization transaction data including transaction detail data and contract information of a smart contract used for processing the transaction detail data;

a third acquiring module, configured to acquire, from a database, a target data set corresponding to the synchronization transaction data, the target data set including read data or result data obtained when the transaction detail data is processed based on the contract information; and

a fourth acquiring module, configured to: acquire, from the synchronization block, verification data corresponding to the synchronization transaction data, and transmit the synchronization transaction data, the verification data, and the target data set to the light node, so that the light node verifies, according to the verification data and the target data set, validity of the synchronization transaction data and to-be-verified result data corresponding to the transaction detail data.

An aspect of the embodiments of this application provides a data synchronization apparatus, including:

a request transmitting module, configured to transmit a data synchronization request that carries a block identifier to a full node, so that the full node acquires synchronization transaction data in a synchronization block according to the block identifier, acquires a target data set corresponding to the synchronization transaction data from a database, and acquires verification data corresponding to the synchronization transaction data from the synchronization block, the block identifier being used for representing an identifier of the requested synchronization block, the synchronization transaction data including transaction detail data and contract information of a smart contract used by the full node to process the transaction detail data, and the target data set including read data or result data obtained by the full node in a case of processing the transaction detail data based on the contract information;

a data acquiring module, configured to acquire the synchronization transaction data, the verification data, and the target data set that are transmitted by the full node; and

a data verification module, configured to verify, according to the verification data and the target data set, validity of the synchronization transaction data and to-be-verified result data corresponding to the transaction detail data.

An aspect of this application provides a computer device, including: a processor, a memory, and a network interface,

the processor being connected to the memory and the network interface, the network interface being configured to provide a data communication function, the memory being configured to store a computer program, the processor being configured to invoke the computer program, causing the computer device to perform the method according to the embodiments of this application.

An aspect of the embodiments of this application provides a computer-readable storage medium. The computer-readable storage medium stores a computer program. The computer program is configured to be loaded by a processor to implement the method according to the embodiments of this application.

An aspect of the embodiments of this application provides a computer program product or a computer program. The computer program product or the computer program includes a computer instruction. The computer instruction is stored in a computer-readable storage medium. A processor of a computer device reads the computer instructions from the computer-readable storage medium. The processor executes the computer instructions, to cause the computer device to perform the method of the embodiments of this application.

### BRIEF DESCRIPTION OF THE DRAWINGS

To describe the technical solutions in the embodiments of this application or the related art more clearly, the following outlines the drawings to be used in the description of the embodiments of this application or the related art. Evidently, the drawings outlined below are merely a part of embodiments of this application, and a person of ordinary skill in the art may derive other drawings from the outlined drawings without making any creative effort.

FIG. 1 is a schematic diagram of a system architecture according to an embodiment of this application.

FIG. 2 is a schematic flowchart of a data synchronization method according to an embodiment of this application.

FIG. 3 is a schematic diagram of a data consensus scenario according to an embodiment of this application.

FIG. 4 is a schematic diagram of a data consensus scenario according to an embodiment of this application.

FIG. 5 is a schematic flowchart of a data synchronization method according to an embodiment of this application.

FIG. 6 is a schematic diagram of a data synchronization scenario according to an embodiment of this application.

FIG. 7 is a schematic flowchart of a data synchronization method according to an embodiment of this application.

FIG. 8 is a schematic diagram of a data self-check scenario according to an embodiment of this application.

FIG. 9 is a schematic flowchart of a data synchronization method according to an embodiment of this application.

FIG. 10 is a schematic diagram of a target data storage scenario according to an embodiment of this application.

FIG. 11 is a schematic structural diagram of a data synchronization apparatus according to an embodiment of this application.

FIG. 12 is a schematic structural diagram of a data synchronization apparatus according to an embodiment of this application.

FIG. 13 is a schematic structural diagram of a computer device according to an embodiment of this application.

FIG. 14 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

For ease of understanding, some nouns are first explained as follows:

1. Blockchain: In a narrow sense, the blockchain is a chained data structure that uses a block as a basic unit. In the block, a digital digest is used for checking a previously obtained transaction history, so as to meet a requirement of tamper prevention and scalability in a distributed accounting scenario. In a broad sense, the blockchain further refers to a distributed accounting technology implemented on behalf of a blockchain structure, including distributed consensus, privacy and security protection, point-to-point communication technology, network protocol, smart contract, and the like. The goal of the blockchain is to implement a distributed data record ledger in which only addition is allowed and deletion is not allowed. A basic structure of the ledger bottom layer is a linear linked list. The linked list is composed of “blocks” in series. In a subsequent block, a hash value of a previous block is recorded. Whether each block (and a transaction in the block) is valid can be checked quickly by calculating a hash value. If a node in a network proposes to add a new block, consensus acknowledgment needs to be reached on the block by using a consensus mechanism.

2. Hash value: is also referred to as an information eigenvalue or an eigenvalue. The hash value is generated by converting input data of any length into a password by using a hash algorithm and performing fixed output, and original input data cannot be retrieved by decrypting the hash value. The hash value is a unidirectional encryption function. In a blockchain, each block (except the initial block) contains a hash value of a previous block, which is referred to as a parent block of the current block. The hash value is the core foundation and most important aspect of the blockchain technology. It keeps authenticity of a record and view data and integrity of the blockchain as a whole.

3. Smart contract: is a computer protocol designed to propagate, validate, or execute a contract in an informationalized manner. In a blockchain system, a smart contract is code that can be understood and executed by each node of a blockchain, and may execute any logic and obtain a result. In practical application, a smart contract is managed and tried through a transaction on the blockchain. Each transaction is equivalent to a remote procedure call (RPC) request for the blockchain system. If the smart contract is equivalent to an executable program, the blockchain is equivalent to an operating system that provides an operating environment. The blockchain may include a plurality of contracts, which are distinguished by a contract identity (ID), an identification number, or a name.

4. Contract management: may be divided into management operations such as deployment, upgrade, and deletion. Execution logic of a contract is changed by initiating a transaction (request) to create or change a code of a specified contract in a blockchain system (that is, a smart contract, and the contract described below refers to a smart contract).

5. Contract execution: By initiating a transaction, a user can call a contract already deployed on a blockchain. All nodes in a blockchain system run the same contract separately. For a contract that needs to read data, the contract accesses a node's own ledger. Finally, all nodes verify whether execution results are consistent with each other (consensus verification). If the execution results are consistent, the nodes store necessary results in their ledgers and return the results to the user.

6. Read/write set: is an operation record of node ledger data during contract execution. It is divided into a read set and a write set, and refers to data read from the ledger and data to be written into the ledger when a smart contract is executed.

7. Full node and light node: A blockchain network includes a full node and a light node. The full node has all data, and the light node has some data. However, the light node still needs to verify whether data synchronized from the full node is authentic and reliable. For example, a tax bureau is a full node, a provincial tax bureau is a light node, and a municipal tax bureau is a light node. In another example, a supreme court is a full node and a local court is a light node. In another example, a bank is a full node, and an enterprise is a light node. As long as a service has an inequivalent relationship, a full node and a light node are required in a system to protect data privacy.

8. Merkle tree: is generally referred to as a hash tree or a state tree. As the name implies, it is a tree that stores a hash value. A leaf of the Merkle tree is a hash value of a data block, and the data block includes a file or a set of files. In the embodiments of this application, the data block may be understood as a block. The file refers to a transaction execution result of transaction detail data or transaction detail data in the block.

When a blockchain is used in some scenarios of a government or a commercial organization, not all participating nodes (including a full node and a light node) in the blockchain have sufficient resources and necessity to become consensus nodes of the blockchain. However, for data security consideration, when the blockchain system involves related data of personal privacy or national security, a common blockchain deployment manner in which data is deployed equally is also not applicable. Therefore, this application provides a method for ensuring data privacy and appropriately disclosing data.

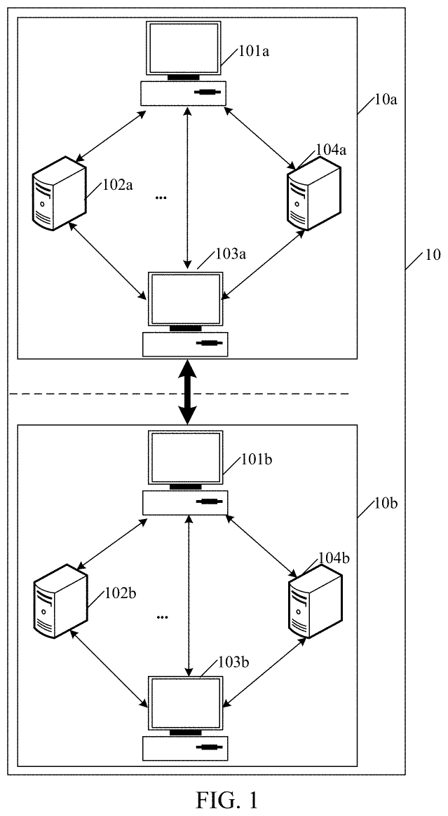

FIG. 1 is a schematic diagram of a system architecture according to an embodiment of this application. As shown in FIG. 1, the system architecture may be a blockchain network 10, where the blockchain network 10 may include a witness network 10a and a consensus network 10b. A node in the witness network 10a may be referred to as a light node, and has some data. The light node mainly performs service execution, does not participate in accounting consensus, and obtains, in an identity authentication manner from the consensus network 10b, block header data and partial authorized visible block data (that is, the foregoing synchronization transaction data). The consensus network 10b may also be referred to as a core network, a node in the consensus network 10b may be referred to as a full node, and the full node has full data. The witness network 10a and the consensus network 10b are located in different network environments. Generally speaking, the witness network 10a is located in a public network, and the consensus network 10b is located in a private network. The witness network 10a and the consensus network 10b interact by using a routing boundary.

Referring to FIG. 1 again, the witness network 10a may include a light node 101a, a light node 102a, a light node 103a, . . . , and a light node 104a. It may be understood that the witness network 10a may include one or more witness networks. In actual application, one or more types of witness networks may be set due to different application scenarios, and a quantity of witness networks is not limited herein. The witness network 10a may include one or more light nodes, and a quantity of light nodes is not limited herein.

Referring to FIG. 1 again, the consensus network 10b may include a full node 101b, a full node 102b, a full node 103b, . . . , and a full node 104b. It may be understood that the consensus network 10b may include one or more consensus networks. In actual application, one or more types of consensus networks may be set due to different application scenarios, and a quantity of consensus networks is not limited herein. The consensus network 10b may include one or more full nodes, and a quantity of full nodes is not limited herein.

When performing normal working, each node (including the light node in the witness network 10a and the full node in the consensus network 10b) may receive data transmitted by the outside, and perform chaining processing based on the received data, or may transmit data to the outside. To ensure data interworking between nodes, there may be a data connection between each node, for example, there is a data connection between the light node 101a and the light node 102a, there is a data connection between the light node 101a and the light node 103a, and there is a data connection between the full node 101b and the full node 104b.

Further, there is a data connection between the witness network 10a and the consensus network 10b, for example, there is a data connection between the light node 101a and the full node 102b, there is a data connection between the light node 101a and the full node 103b, and there is a data connection between the full node 101b and the light node 104a.

It may be understood that data or block transmission may be performed between nodes by using the foregoing data connection. The foregoing data connection between nodes may be based on a node identifier. Each node in the blockchain network 10 has a node identifier corresponding to the node, and each node may store a node identifier of another node connected to the node, so that obtained data or a generated block is subsequently broadcast to the another node according to the node identifier of the another node. For example, in the light node 101a, a node identifier list shown in Table 1 may be maintained, and the node identifier list stores a node name and a node identifier of another node.

TABLE 1

| Node name | Node identifier |
|---|---|
| Light node 102a | 117.114.151.174 |
| Light node 103a | 117.116.189.145 |
| . . . | . . . |
| Light node 104a | 119.123.789.258 |
| Full node 101b | 117.114.151.183 |
| Full node 102b | 117.116.189.125 |
| Full node 103b | 119.250.485.362 |
| Full node 104b | 119.123.789.369 |

The node identifier may be an Internet Protocol (IP) address and any other information that can be used for identifying a node in the blockchain network 10. In Table 1, only an IP address is used as an example for description.

Assuming that the node identifier of the light node 101a is 117.116.156.425, the light node 101a may transmit a data synchronization request to the full node 101b by using the node identifier 117.114.151.183, and the full node 101b may learn, by using the node identifier 117.116.156.425, that the data synchronization request is transmitted by the light node 101a. Similarly, the light node 101a may transmit transaction data A to the light node 103a by using the node identifier 117.116.189.145, and the light node 103a may learn, by using the node identifier 117.116.156.425, that transaction data A is transmitted by the light node 101a, and data transmission between other nodes is also the same. Therefore, details are not described herein again.

It may be understood that the foregoing data connection does not limit a connection manner, and the nodes may be directly or indirectly connected in a wired communication manner, may be directly or indirectly connected in a wireless communication manner, or may be connected in another connection manner, which is not limited in this application.

In FIG. 1, the light node 101a, the light node 102a, the light node 103a, . . . , the light node 104a, the full node 101b, the full node 102b, the full node 103b, . . . , and the full node 104b may include a mobile phone, a tablet computer, a notebook computer, a palmtop computer, a smart box, a mobile internet device (MID), a point of sales (POS) machine, a wearable device (such as a smart watch or a smart band), and the like.

It may be understood that the data synchronization method provided in this embodiment of this application may be performed by a computer device, and the computer device includes but is not limited to a light node (may be a terminal or a server) or a full node (may be a terminal or a server). The server may be a stand-alone physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smartphone, a tablet computer, a notebook computer, a desktop computer, a smart speaker, a smart watch, or the like, but is not limited thereto. The terminal and the server may be directly or indirectly connected in a wired or wireless communication manner. This is not limited in this application.

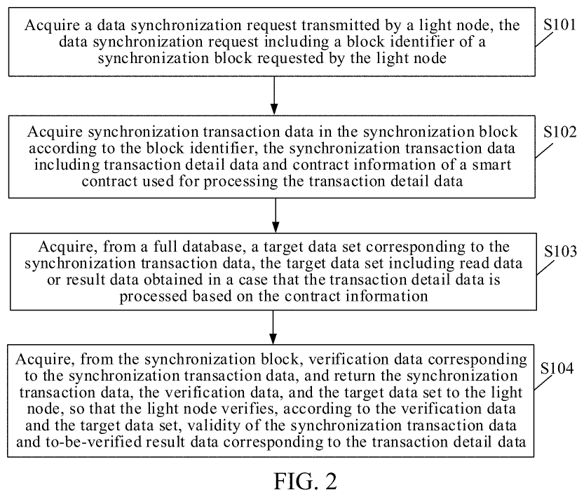

Further, FIG. 2 is a schematic flowchart of a data synchronization method according to an embodiment of this application. The data synchronization method is performed by a computer device. For example, the data synchronization method may be performed by the full node or the light node in FIG. 1, or may be jointly performed by the full node and the light node. In this embodiment of this application, that the data synchronization method is performed by the full node is used as an example for description. As shown in FIG. 2, the data synchronization process may include the following steps.

Step S101: Acquire a data synchronization request transmitted by a light node. The data synchronization request includes a block identifier of a synchronization block requested by the light node.

Specifically, acquire the transaction detail data in a to-be-chained block, and call a transaction execution function in the smart contract used for processing the transaction detail data; acquire historical transaction data for the transaction detail data according to the transaction execution function, and determine the historical transaction data as the read data; execute the transaction execution function according to the historical transaction data and the transaction detail data, to obtain a transaction execution result of the transaction detail data; and perform chaining processing on the to-be-chained block according to the transaction detail data and the transaction execution result.

A specific process of performing chaining processing on the to-be-chained block according to the transaction detail data and the transaction execution result may include: generating the result data according to the transaction execution result when the transaction detail data and the transaction execution result both pass consensus verification; generating a transaction state tree according to the transaction detail data, generating a result state tree according to the result data, and adding the transaction state tree and the result state tree to the to-be-chained block; determining the to-be-chained block added with the transaction state tree and the result state tree as the synchronization block, and adding the synchronization block to a blockchain; and generating the target data set according to the read data and the result data, and storing the target data set in the database. The transaction state tree is a transaction Merkle tree generated based on the transaction detail data. The result state tree is a result Merkle tree generated based on the result data.

An implementation process of “generating the target data set according to the read data and the result data, and storing the target data set in the database” is: separately comparing the read data and the result data with a historical data set (e.g., comparing the read data with the historical data set, and comparing the result data with the historical data set); the historical data set including historical read data or historical result data that is in the database and corresponds to historical transaction detail data; in accordance with a determination that a historical data set matches the read data exists and a historical data set matches the result data, marking the historical data set matching the read data with a read mark, setting a historical data set having a read mark as a first data set, marking the historical data set matching the result data with a write mark, setting a historical data set having a write mark as a second data set, and setting the first data set and the second data set as the target data set; in accordance with a determination that no historical data set matches the read data and no historical data set matching the result data exists; and associatively storing the target data set and the transaction detail data in the database.

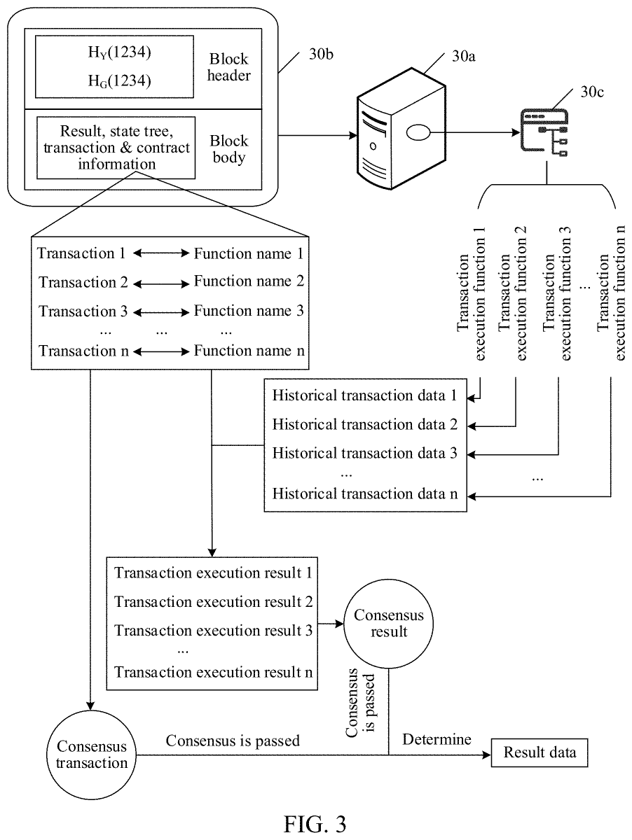

FIG. 3 is a schematic diagram of a data consensus scenario according to an embodiment of this application. As shown in FIG. 3, a full node 30a acquires a to-be-chained block 30b, where the to-be-chained block 30b may be a to-be-consensus block generated by another full node in a blockchain network, or may be a to-be-blocked block generated by a light node in the blockchain network, which is not limited herein. It may be understood that this embodiment of this application describes only a transaction root hash (a hash value HY(1234) in FIG. 3) and a result root hash (a hash value HG(1234) in FIG. 3) in a block header. In actual application, basic data such as a version number, a time stamp, and a difficulty value are stored in the block header, or other related data may be stored.

Referring to FIG. 3 again, the full node 30a acquires transaction detail data in the to-be-chained block 30b, that is, transaction 1, transaction 2, transaction 3, . . . , and transaction n in FIG. 3. Sequencing consensus is performed on transaction 1, transaction 2, transaction 3, . . . , and transaction n. When sequencing passes consensus verification, transaction execution result consensus is performed on transaction 1, transaction 2, transaction 3, . . . , and transaction n. For a specific process, refer to the following description. The full node 30a first calls a transaction execution function in a smart contract 30c used for processing transaction detail data. As shown in FIG. 3, a function of executing transaction 1 is a transaction execution function 1, a function of executing transaction 2 is a transaction execution function 2, and a function of executing transaction 3 is a transaction execution function 3, . . . , and a function of executing transaction n is a transaction execution function n. It may be understood that functions (including functions respectively corresponding to a function name 1, a function name 2, a function name 3, . . . , and a function name n) may be called in the same smart contract, or may be called in different smart contracts. For example, the function corresponding to the function name 1 and the function corresponding to the function name 2 are called in a smart contract B, and the function corresponding to the function name 3 and the function corresponding to the function name n are called in a smart contract V.

The full node 30a acquires historical transaction data for the transaction detail data according to the transaction execution function, and determines the historical transaction data as the read data. As shown in FIG. 3, the transaction execution function 1 is used for acquiring historical transaction data 1 of transaction 1, the transaction execution function 2 is used for acquiring historical transaction data 2 of transaction 2, the transaction execution function 3 is used for acquiring historical transaction data 3 of transaction 3, . . . , and the transaction execution function n is used for acquiring historical transaction data n of transaction n. For example, transaction 1 is transferred CNY 10 from Party A to Party B by using an account of Party A, the transaction execution function 1 is a transfer execution function, the historical transaction data 1 is CNY 20 remaining in the account of Party A, and a transaction execution result 1 for transaction 1 may be 20−10=CNY 10, that is, after transaction 1 is executed, CNY 10 is remaining in the account of Party A.

The foregoing uses transaction 1 as an example to describe a relationship between the transaction detail data, the historical transaction data, and the transaction execution result. Therefore, a transaction execution result 2 of transaction 2 may be obtained according to transaction 2, the historical transaction data 2, and the transaction execution function 2. A transaction execution result 3 of transaction 3 may be obtained according to transaction 3, the historical transaction data 3, and the transaction execution function 3, . . . , and a transaction execution result n of transaction n may be obtained according to transaction n, the historical transaction data n, and the transaction execution function n.

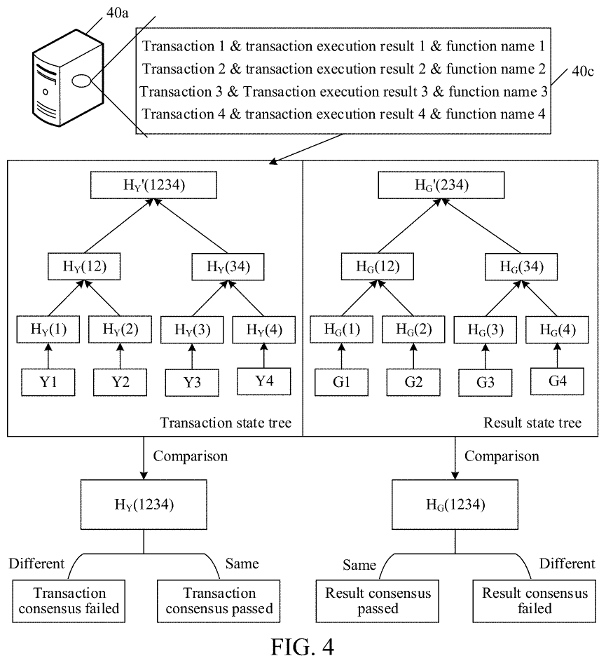

FIG. 4 is a schematic diagram of a data consensus scenario according to an embodiment of this application. A full node 40a in FIG. 4 may be equivalent to the full node 30a in FIG. 3. Assuming that n in FIG. 3 is equal to 4, the full node 40a may obtain to-be-consensus data 40c in FIG. 4. The to-be-consensus data 40c may include the associated transaction 1, execution result 1, and function name 1, the associated transaction 2, execution result 2, and function name 2, the associated transaction 3, execution result 3, and function name 3, and the associated transaction 4, execution result 4, and function name 4.

Referring to FIG. 4 again, the full node 40a first separately performs hash calculation on transaction 1 (equivalent to Y1 in FIG. 4), transaction 2 (equivalent to Y2 in FIG. 4), transaction 3 (equivalent to Y3 in FIG. 4), and transaction 4 (equivalent to Y4 in FIG. 4), to obtain a hash value HY(1) of transaction 1, a hash value HY(2) of transaction 2, a hash value HY(3) of transaction 3, and a hash value HY(4) of transaction 4. Then a hash operation is performed on the hash value HY(1) and the hash value HY(2) to obtain a hash value HY(12) that includes the foregoing two hash values, and a hash operation is performed on the hash value HY(3) and the hash value HY(4) to obtain a hash value HY(34) that includes the foregoing two hash values. Finally, a hash operation is performed on the hash value HY(12) and the hash value HY(34) to obtain a hash value HY′(1234) that includes the hash value HY(12) and the hash value HY(34), where the hash value HY′(1234) is a to-be-verified transaction root hash of the to-be-consensus data 40c.

Similarly, the full node 40a first separately performs hash calculation on the transaction execution result 1 (equivalent to G1 in FIG. 4), the transaction execution result 2 (equivalent to G2 in FIG. 4), the transaction execution result 3 (equivalent to G3 in FIG. 4), and the transaction execution result 4 (equivalent to G4 in FIG. 4), to obtain a hash value HG(1) of the transaction execution result 1, a hash value HG(2) of the transaction execution result 2, a hash value HG(3) of the transaction execution result 3, and a hash value HG(4) of the transaction execution result 4. Then a hash operation is performed on the hash value HG(1) and the hash value HG(2) to obtain a hash value HG(12) that includes the foregoing two hash values, and a hash operation is performed on the hash value HG(3) and the hash value HG(4) to obtain a hash value HG(34) that includes the foregoing two hash values. Finally, a hash operation is performed on the hash value HG(12) and the hash value HG(34) to obtain a hash value HG′(1234) that includes the hash value HG(12) and the hash value HG(34), where the hash value HG′(1234) is a to-be-verified result root hash of the to-be-consensus data 40c.

It may be understood that, in this embodiment of this application, four transactions are used as an example for description, and do not represent a transaction quantity in an actual application scenario.

The full node 40a compares the hash value HY′(1234) with the hash value HY(1234) in FIG. 3. If the hash value HY′(1234) matches (e.g., is the same as) the hash value HY(1234) in FIG. 3, it may be determined that transaction consensus of the to-be-consensus data 40c is passed; otherwise, the transaction consensus fails. Similarly, the full node 40a compares the hash value HG′(1234) with the hash value HG(1234) in FIG. 3. If the hash value HG′(1234) is the same as the hash value HG(1234) in FIG. 3, it may be determined that result consensus of the to-be-consensus data 40c is passed; otherwise, the result consensus fails. Referring to FIG. 3 again, when the transaction detail data and the transaction execution result both pass consensus verification, the full node 30a generates result data according to the transaction execution result.

It may be understood that, in this embodiment of this application, an example in which the result data includes the transaction execution result is used for description, and is also used in the following. In an actual application scenario, the result data includes but is not limited to the transaction execution result, and a range of the result data may be set according to a scenario.

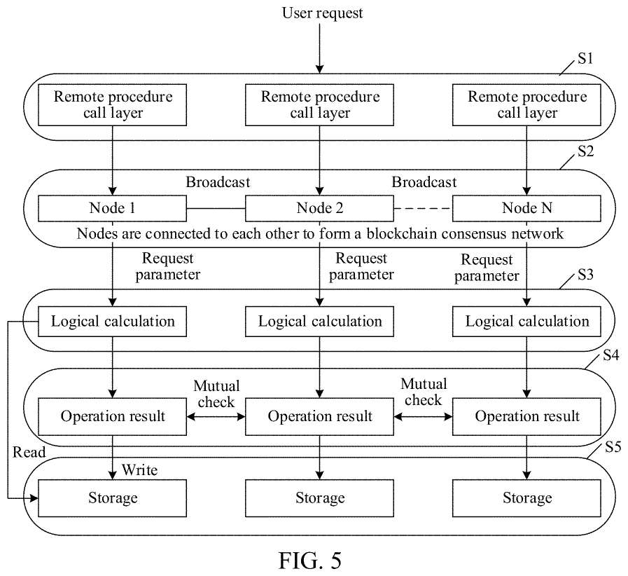

For the foregoing process, refer to FIG. 5. FIG. 5 is a schematic flowchart of a data synchronization method according to an embodiment of this application. The method may be performed by any node in a blockchain network. As shown in FIG. 5, the data synchronization method may include the following steps.

Step S1: Each node RPC layer acquires a user request, where the user request is also referred to as a transaction.

Step S2: Each node broadcasts a transaction to each other, and one of the nodes packages several transactions into one block, and broadcasts the block to another node. Selection of a blocking node varies according to a consensus algorithm, and may include leader blocking, blocking in turn, power contention blocking, and the like.

Step S3: After receiving the block, each node starts to execute the transactions in the block (that is, the user request). At a logic calculation layer, a transaction parameter is parsed and a contract is executed. In an execution process, it may be necessary to read data in storage (that is, read data). For example, node 1 in FIG. 5 reads historical transaction data from this time.

Step S4: After the contract is executed, each node performs mutual verification on an execution result (that is, the foregoing transaction execution result). The verification method may be organizing the execution result or a stored change into a result Merkle tree, placing a result tree root (that is, a result root hash) into a block header, and finally verifying whether each node block hash is consistent.

Step S5: After consensus succeeds, each node may store data related to a local block, mainly including a block header, all transactions included in the block, a contract execution result, and the like.

For a detailed process of step S1 to step S5, refer to step S101 in the embodiment corresponding to FIG. 2. Details are not described herein again.

Step S102: Acquire synchronization transaction data in the synchronization block according to the block identifier. The synchronization transaction data includes transaction detail data and contract information of a smart contract used for processing the transaction detail data.

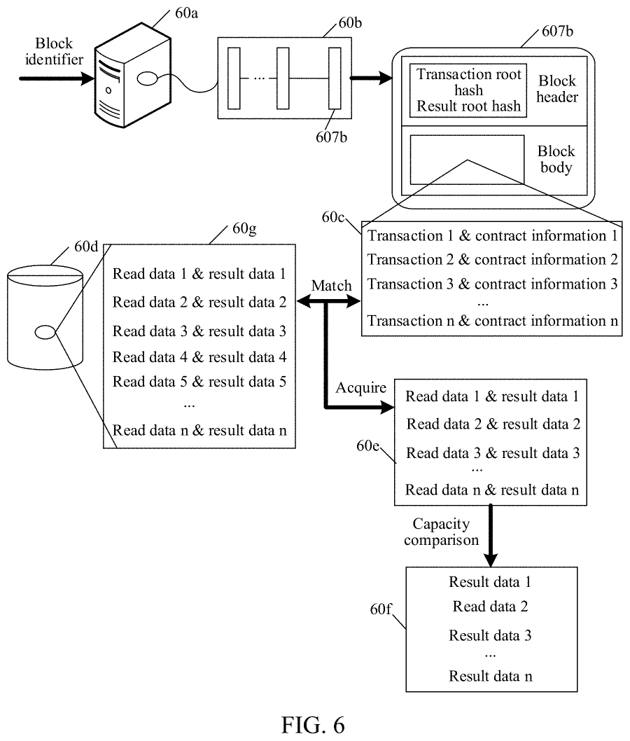

Specifically, referring to FIG. 6, FIG. 6 is a schematic diagram of a data synchronization scenario according to an embodiment of this application. As shown in FIG. 6, a full node 60a may determine, in a full ledger 60b according to a block identifier transmitted by a light node, a synchronization block 607b requested by the light node, where the block identifier may be a block height of the synchronization block 607b, may be a block hash of the synchronization block 607b, or may be another identifier that may represent the synchronization block 607b.

The full node 60a acquires synchronization transaction data 60c in the synchronization block 607b. The synchronization transaction data 60c may include transaction 1 and contract information 1 that are associatively stored in FIG. 6, transaction 2 and contract information 2 that are associatively stored, and transaction 3 and contract information 3 that are associatively stored, . . . , and transaction n and contract information n that are associatively stored.

Step S103: Acquire, from a database, a target data set corresponding to the synchronization transaction data. The target data set includes read data or result data obtained by processing the transaction detail data based on the contract information.

Specifically, acquire, from the database, the target data set corresponding to the synchronization transaction data; the candidate data set including read data and result data; compare a data capacity of the read data with a data capacity of the result data; determine the read data as the target data set in accordance with a determination that the data capacity of the read data is less than the data capacity of the result data; and determine the result data as the target data set in accordance with a determination that the data capacity of the read data is equal to or greater than the data capacity of the result data.

Referring to FIG. 6 again, after acquiring the synchronization transaction data 60c, the full node 60a further needs to acquire a target data set 60f corresponding to the synchronization transaction data 60c, so that the light node can execute a transaction execution function according to the target data set 60f and the transaction detail data. The full node 60a first acquires a database 60d, and then acquires a historical data set 60g in the database 60d. As shown in FIG. 6, the historical data set 60g may include read data 1 & result data 1, read data 2 & result data 2, read data 3 & result data 3, read data 4 & result data 4, read data 5 & result data 5, . . . , and read data n & result data n, where the symbol “&” indicates associative storage.

It may be learned from the description in step S101 that the full node associatively stores the target data set and the transaction detail data in the database. Therefore, the full node 60a herein may match the transaction detail data in the synchronization transaction data 60c (including transaction 1, transaction 2, transaction 3, . . . , and transaction n in FIG. 6) with the transaction detail data in the database 60d, and a candidate data set 60e of the synchronization transaction data 60c may be determined according to a matching result. It is assumed that a target data set of transaction 1 is read data 1 & result data 1; a target data set of transaction 2 is read data 2 & result data 2, and a target data set of transaction 3 is read data 3 & result data 3, . . . , and a target data set of transaction n is read data n & result data n.

The full node 60a does not need to transmit both the read data and the result data of the transaction detail data to the light node. The light node may verify, according to the read data or the result data, whether the synchronization transaction data transmitted by the full node 60a and to-be-verified result data corresponding to the transaction detail data are valid. Therefore, the full node 60a may compare read data 1 and result data 1 of transaction 1 with a data capacity of result data 1. If the data capacity of result data 1 is smaller, result data 1 is determined as the target data set of transaction 1. Similarly, the full node 60a may perform data capacity comparison between read data 2 and result data 2 of transaction 2. If the data capacity of read data 2 is smaller, read data 2 is determined as the target data set of transaction 2. The full node 60a may perform data capacity comparison between read data 3 and result data 3 of transaction 3. If the data capacity of result data 3 is smaller, result data 3 is determined as the target data set of transaction 3. By analogy, the target data set 60f is generated.

The database 60d may be considered as an electronic file cabinet, where an electronic file (the electronic file in this application may refer to the target data set and the transaction detail data) is stored. The full node 60a may perform operations such as adding, querying, updating, and deleting the target data set and the transaction detail data in the file. The so-called “database” is a data set that is stored together in a specific manner, can be shared with a plurality of users, has as little redundancy as possible, and is independent of an application program.

Step S104: Acquire, from the synchronization block, verification data corresponding to the synchronization transaction data, and transmit the synchronization transaction data, the verification data, and the target data set to the light node, so that the light node verifies, according to the verification data and the target data set, validity of the synchronization transaction data and to-be-verified result data corresponding to the transaction detail data.

Specifically, the verification data includes transaction verification data and result verification data; acquire a transaction state tree and a result state tree from the synchronization block; acquire the transaction verification data from the transaction state tree based on the transaction detail data; and acquire the result verification data from the result state tree based on the result data.

The data synchronization request further includes a node identifier of the light node; determine a synchronization permission of the light node for the synchronization transaction data according to the node identifier; the synchronization permission includes a synchronization valid permission and a synchronization invalid permission; transmit data synchronization failure information to the light node in accordance with a determination that the synchronization permission of the light node for the synchronization transaction data is the synchronization invalid permission; and transmit the synchronization transaction data, the verification data, and the target data set to the light node in accordance with a determination that the synchronization permission of the light node for the synchronization transaction data is the synchronization valid permission.

Referring to FIG. 4 again, a synchronization block 40b includes a state tree (including the transaction state tree and the result state tree in FIG. 4). Therefore, the full node may obtain verification data of the synchronization transaction data (including the transaction detail data and the contract information) from the synchronization block 40b, where the transaction verification data may be corresponding to a transaction hash value in the transaction state tree, and the result verification data may be corresponding to a result hash value in the result state tree. The following uses transaction 1 in FIG. 4 as an example for description. For transaction 1, transaction verification data of transaction 1 may include a hash value HY(2) and a hash value HY(34), and result verification data of transaction 1 may be a hash value HG(2) and a hash value HG(34).

After the verification data is obtained, the full node determines that the light node acquires the synchronization permission of the synchronization transaction data. It is to be understood that, in this embodiment of this application, a method for determining the synchronization permission is not limited, and the synchronization permission may be determined using a node identifier of the light node, or the synchronization permission may be determined by using a node type of the light node, or may be determined by using another method. The node identifier is used as an example in this embodiment of this application for description.

It may be understood that, in the foregoing, after obtaining the synchronization transaction data, the target data set, and the verification data, the full node determines the synchronization permission of the light node for the synchronization transaction data. In actual application, alternatively, after obtaining the synchronization transaction data, the full node may determine the synchronization permission of the light node for the synchronization transaction data, and then obtain the target data set and the verification data according to the synchronization permission. Alternatively, after obtaining the synchronization transaction data and the target data set, the full node may determine the synchronization permission of the light node for the synchronization transaction data, and then acquire the verification data according to the synchronization permission. In this embodiment of this application, a time for determining the synchronization permission of the synchronization transaction data is also not limited. In actual application, the synchronization permission may be set according to a scenario.

Referring to FIG. 4 again, it may be understood that verification data transmitted to a light node may include verification data respectively corresponding to each piece of transaction detail data. For example, for transaction 1, the verification data may include a hash value HY(2) and a hash value HY(34), and a hash value HG(2) and a hash value HG(34). For transaction 2, the verification data may include a hash value HY(1) and a hash value HY(34), and the hash value HG(1) and the hash value HG(34). Verification data for all transaction detail data may also be included. For example, for transaction 1 and transaction 2, the verification data may include the hash value HY(34) and the hash value HG(34).

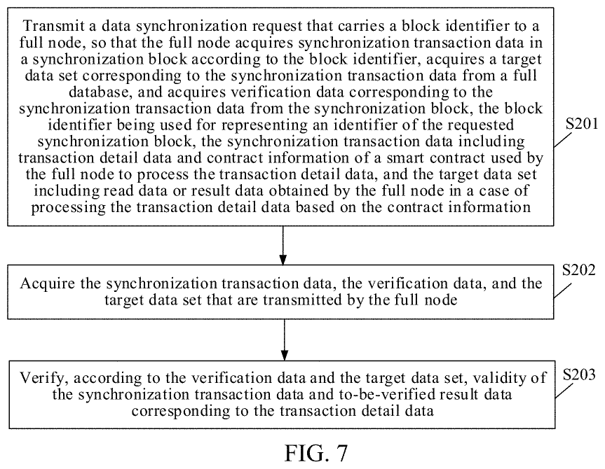

Further, the full node transmits the synchronization transaction data, the verification data, and the target data set to the light node, so that the light node verifies, according to the verification data and the target data set, validity of the synchronization transaction data and to-be-verified result data corresponding to the transaction detail data. For a specific process of self-checking, by the light node, validity of the synchronization transaction data and the to-be-verified result data corresponding to the transaction detail data, refer to the following embodiment corresponding to FIG. 7.

In this embodiment of this application, when a data synchronization request transmitted by the light node for a block is obtained, the entire synchronization block is not transmitted to the light node in this application. The synchronization transaction data is first obtained, the target data set and the verification data for the synchronization transaction data are then obtained, and the synchronization transaction data, the verification data, and the target data set are transmitted to the light node, so that the light node can execute a smart contract in a case in which only a part of data (not the entire synchronization block) is owned, perform a service logical operation on the data, and process a complex service. In the foregoing process, all nodes (including the light node and the full node) whose data are not equal to each other may execute a contract, so that a capability of a smart contract is fully utilized while data privacy protection is implemented, thereby determining accuracy of the data. In addition, because the target data set includes the read data or the result data that is obtained when the contract information is used for processing the transaction detail data, the light node may accurately obtain the to-be-verified result data of the transaction detail data by using the target data set. Based on the verification data, the light node may have permission to self-verify the synchronization transaction data and validity of the to-be-verified result data. With the permission, the light node may improve accuracy of verifying validity of the synchronization transaction data and the to-be-verified result data.

Further, FIG. 7 is a schematic flowchart of a data synchronization method according to an embodiment of this application. The data synchronization method is performed by a computer device. The data synchronization method may be performed by the full node or the light node in FIG. 1, or may be jointly performed by the full node and the light node. In this embodiment of this application, that the data synchronization method is performed by the light node is used as an example for description. As shown in FIG. 7, the data synchronization process includes the following steps:

Step S201: Transmit a data synchronization request that carries a block identifier to a full node, so that the full node acquires synchronization transaction data in a synchronization block according to the block identifier, acquires a target data set corresponding to the synchronization transaction data from a database, and acquires verification data corresponding to the synchronization transaction data from the synchronization block; the block identifier being used for representing an identifier of the requested synchronization block; the synchronization transaction data including transaction detail data and contract information of a smart contract used by the full node to process the transaction detail data; and the target data set including read data or result data obtained by the full node in a case of processing the transaction detail data based on the contract information.

For a specific process of step S201, refer to the foregoing description in the embodiment corresponding to FIG. 2. Details are not described herein again.

Step S202: Acquire the synchronization transaction data, the verification data, and the target data set that are transmitted by the full node.

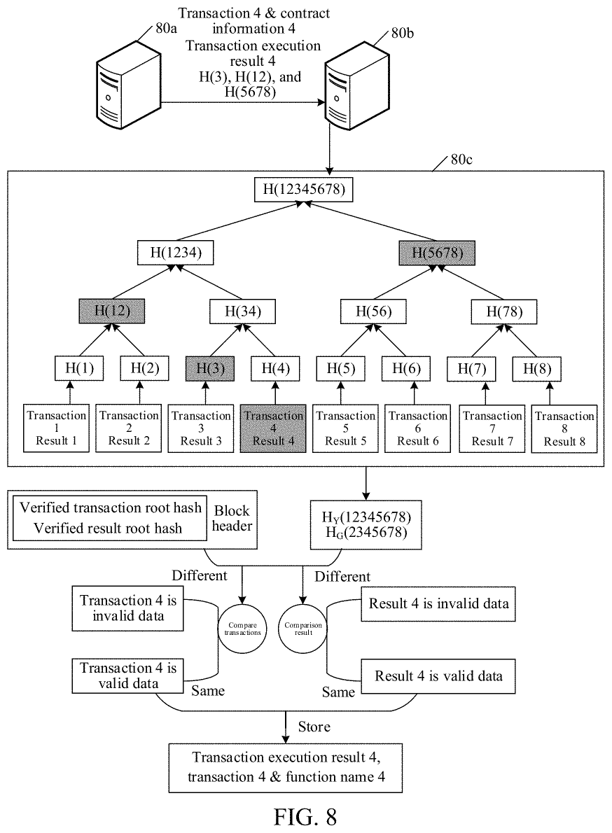

Specifically, FIG. 8 is a schematic diagram of a data self-check scenario according to an embodiment of this application. As shown in FIG. 8, a light node 80b acquires synchronization transaction data (that is, transaction 4 & contract information 4 in FIG. 8), verification data (that is, H(3), H(12), and H(5678) in FIG. 8), and a target data set (that is, a transaction execution result 4 in FIG. 8, which is equivalent to the foregoing result data) that are transmitted by a full node 80a. The verification data H(3) may include a hash value HY(3) and a hash value HG(3), the verification data H(12) may include a hash value HY(12) and a hash value HG(12), and the verification data H(5678) may include a hash value HY(5678) and a hash value HG(5678). Similarly, any hash value H(E) in a Merkle proof tree 80c in FIG. 8 may include a transaction hash value HY(E) and a result hash value HG(E), where E is equal to 1, 2, 3, . . . , and 8.

Step S203: Verify, according to the verification data and the target data set, validity of the synchronization transaction data and to-be-verified result data corresponding to the transaction detail data.

Specifically, determine the result data as the to-be-verified result data in accordance with a determination that the target data set is the result data; obtain a first to-be-verified root hash according to the transaction detail data, the to-be-verified result data, and the verification data; and verify validity of the synchronization transaction data and the to-be-verified result data according to the first to-be-verified root hash.

In another example, determine the smart contract according to a contract name in the contract information in accordance with a determination that the target data set is the read data; determine, according to a function name in the contract information, a transaction execution function called by the smart contract to process the transaction detail data; and obtain a second to-be-verified root hash according to the read data, the transaction execution function, the transaction detail data, and the verification data, and verify validity of the synchronization transaction data and the to-be-verified result data according to the second to-be-verified root hash.

A specific process of obtaining a first to-be-verified root hash according to the transaction detail data, the to-be-verified result data, and the verification data; and verifying validity of the synchronization transaction data and the to-be-verified result data according to the first to-be-verified root hash may include: the verification data including transaction verification data and result verification data; the first to-be-verified root hash including a to-be-verified transaction root hash and a to-be-verified result root hash; obtaining a to-be-verified transaction root hash according to the transaction detail data and the transaction verification data; and obtaining the to-be-verified result root hash according to the to-be-verified result data and the result verification data; acquiring a block header for the synchronization block, and acquiring a verified transaction root hash and a verified result root hash from the block header; and determining validity of the synchronization transaction data and the to-be-verified result data according to the to-be-verified transaction root hash, the to-be-verified result root hash, the verified transaction root hash, and the verified result root hash.

A specific process of determining validity of the synchronization transaction data and the to-be-verified result data according to the to-be-verified transaction root hash, the to-be-verified result root hash, the verified transaction root hash, and the verified result root hash may include: comparing the to-be-verified transaction root hash with the verified transaction root hash, in accordance with a determination that the to-be-verified transaction root hash is different from the verified transaction root hash, determining that the synchronization transaction data is invalid data, and in accordance with a determination that the to-be-verified transaction root hash is the same as the verified transaction root hash, determining that the synchronization transaction data is valid data; comparing the to-be-verified result root hash with the verified result root hash, in accordance with a determination that the to-be-verified result root hash is different from the verified result root hash, determining that the to-be-verified result data is invalid data, and in case that the to-be-verified result root hash is the same as the verified result root hash, determining that the to-be-verified result data is valid data; and when the synchronization transaction data is valid data and the to-be-verified result data is valid data, associatively storing the to-be-verified result data and the synchronization transaction data.

A specific process of obtaining a second to-be-verified root hash according to the read data, the transaction execution function, the transaction detail data, and the verification data may include: the verification data including transaction verification data and result verification data; inputting the read data and the transaction detail data into the transaction execution function to obtain a to-be-verified transaction execution result of the transaction detail data, and generating the to-be-verified result data according to the to-be-verified transaction execution result; obtaining the to-be-verified result root hash according to the to-be-verified result data and the result verification data; obtaining a to-be-verified transaction root hash according to the transaction detail data and the transaction verification data; and determining the to-be-verified result root hash and the to-be-verified transaction root hash as the second to-be-verified root hash.

A specific process of verifying validity of the synchronization transaction data and the to-be-verified result data corresponding to the transaction detail data according to the second to-be-verified root hash may include: acquiring a block header for the synchronization block, and acquiring a verified transaction root hash and a verified result root hash from the block header; comparing the to-be-verified transaction root hash with the verified transaction root hash, in accordance with a determination that the to-be-verified transaction root hash is different from the verified transaction root hash, determining that the synchronization transaction data is invalid data, where in this case, the to-be-verified result root hash is not compared with the verified result root hash; and in accordance with a determination that the to-be-verified transaction root hash is the same as the verified transaction root hash, determining that the synchronization transaction data is valid data. Further, comparing the to-be-verified result root hash with the verified result root hash, in accordance with a determination that the to-be-verified result root hash is different from the verified result root hash, determining that the to-be-verified result data is invalid data, and in case that the to-be-verified result root hash is the same as the verified result root hash, determining that the to-be-verified result data is valid data, and associatively storing the to-be-verified result data and the synchronization transaction data.

The target data set is result data (for example, a transaction execution result 4 in FIG. 8). The light node does not need to execute the transaction detail data in the synchronization transaction data. In this case, the result data transmitted by the full node is the to-be-verified result data of the transaction detail data. The light node may verify the validity of the synchronization transaction data according to the result data, the verification data, and the transaction detail data. For a specific process, refer to FIG. 8. The light node 80b may generate a Merkle proof tree 80c (in this case, it is a Merkle transaction proof tree) according to transaction 4, the hash value HY(3), the hash value HY(12), and the hash value HY(5678). The light node 80b first performs a hash operation on transaction 4 to obtain a hash value HY(4), may obtain a hash value HY(34) according to the hash value HY(4) and the hash value HY(3), and may obtain a hash value HY(1234) according to the hash value HY(34) and the hash value HY(12); and finally, may obtain a hash value HY(12345678) according to the hash value HY(1234) and the hash value HY(5678) in the verification data, where the hash value HY(12345678) is a to-be-verified transaction hash.

Similarly, the light node 80b may generate a Merkle proof tree 80c (in this case, it is a Merkle result proof tree) according to the transaction execution result 4, the hash value HG(3), the hash value HG(12), and the hash value HG(5678). The light node 80b first performs a hash operation on the result 4 (equivalent to the transaction execution result 4) to obtain a hash value HG(4), may obtain a hash value HG(34) according to the hash value HG(4) and the hash value HG(3), and may obtain a hash value HG(1234) according to the hash value HG(34) and the hash value HG(12); and finally, may obtain a hash value HG(12345678) according to the hash value HG(1234) and the hash value HG(5678) in the verification data, where the hash value HG(12345678) is a to-be-verified result hash.

Referring to FIG. 8, the light node 80b acquires a block header of a synchronization block from a P2P network, acquires a verified transaction root hash and a verified result root hash in the block header, compares the to-be-verified transaction root hash (that is, the hash value HY(12345678)) with the verified transaction root hash, and if the to-be-verified transaction root hash is different from the verified transaction root hash, determines that the synchronization transaction data (including the transaction 4) is invalid data, and if the to-be-verified transaction root hash is the same as the verified transaction root hash, determines that the synchronization transaction data is valid data.

The to-be-verified result root hash (that is, the hash value HG(12345678)) is compared with the verified result root hash. If the to-be-verified result root hash is different from the verified result root hash, it is determined that the result data (such as result 4 in FIG. 8) is invalid data; and if the to-be-verified result root hash is the same as the verified result root hash, it is determined that the result data is valid data. When the synchronization transaction data is valid data and the result data is valid data, the light node 80b associatively stores the result data and the synchronization transaction data.

When the target data set is the read data, the light node needs to execute, according to the read data and the transaction detail data, a transaction execution function corresponding to the contract information, so as to generate a to-be-verified transaction execution result of the transaction detail data, and then generate, according to the to-be-verified transaction execution result, the to-be-verified result data corresponding to the transaction detail data. The full node has already executed the transaction detail data, and the read data may cover all the data in the contract execution process. Therefore, in a case in which the light node has only a part of the data, the contract can still be executed. After the to-be-verified transaction execution result is obtained, a self-check process of the light node is basically the same as a process of performing self-check according to the result data in the foregoing. Therefore, details are not described herein again.

It may be learned from the foregoing that the light node may synchronize contract data of any logic, and may self-verify correctness of the data. It may be understood that in this embodiment of this application, self-verification of the light node on the to-be-verified result data and the synchronization transaction data is used as an example for description. In actual application, the light node may set self-verification of the to-be-verified result data or the synchronization transaction data or both according to a scenario, which is not limited herein.

In this embodiment of this application, when a data synchronization request transmitted by the light node for a block is obtained, the entire synchronization block is not transmitted to the light node in this application. The synchronization transaction data is first obtained, the target data set and the verification data for the synchronization transaction data are then obtained, and the synchronization transaction data, the verification data, and the target data set are transmitted to the light node, so that the light node can execute a smart contract in a case in which only a part of data (not the entire synchronization block) is owned, perform a service logical operation on the data, and process a complex service. In the foregoing process, all nodes (including the light node and the full node) whose data are not equal to each other may execute a contract, so that a capability of a smart contract is fully utilized while data privacy protection is implemented, thereby determining accuracy of the data. In addition, because the target data set includes the read data or the result data that is obtained when the contract information is used for processing the transaction detail data, the light node may accurately obtain the to-be-verified result data of the transaction detail data by using the target data set. Based on the verification data, the light node may have permission to self-verify the synchronization transaction data and validity of the to-be-verified result data. With the permission, the light node may improve accuracy of verifying validity of the synchronization transaction data and the to-be-verified result data.

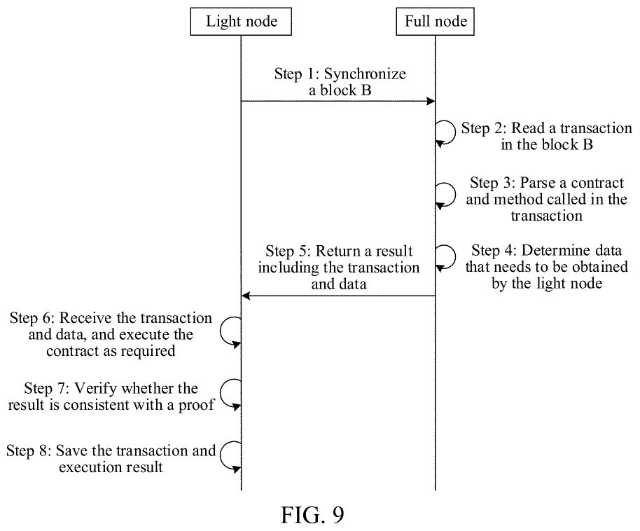

Further, FIG. 9 is a schematic flowchart of a data synchronization method according to an embodiment of this application. The data synchronization method may be performed by a computer device, for example, the light node or the full node in FIG. 1, or may be jointly performed by the light node and the full node. In this embodiment of this application, that the method is jointly performed by the light node and the full node is used as an example for description. As shown in FIG. 9, the data synchronization process includes the following steps:

Step 1: Synchronize a block B.

Specifically, a block header of the block B is broadcast in an entire network, and after receiving the block header, the light node transmits a data synchronization request to the full node to synchronize data in the block B.

Implementation of a smart contract can be divided into two parts: code+data. The code represents a logical service, which is visible to all service participants. Therefore, light nodes of the same service have the code. The core problem to be solved is the data problem, which mainly includes the following two problems: 1. how does the full node identify and distribute correct data to the light node; 2. if a blockchain tolerates malicious behavior, how does the light node perform self-check to determine that the data returned by the full node is not tampered with. Refer to steps 2 to 8 below.

Step 2: Read a transaction in the block B.

Specifically, the data is divided into two parts: transaction detail data and context transaction data. The transaction detail data is stored in the block and is in a final state. The data cannot be modified. The full node can directly return the data to the light node. The context transaction data (equivalent to the target data set in the foregoing) mainly refers to transient data, such as account balance before transfer or account balance after transfer. With the increase of blocks and execution of the transaction, the balance varies every time. Therefore, when the light node synchronizes the block B, the full node needs to be able to read or calculate the account balance when the blockchain network processes the block B, rather than the latest account balance.

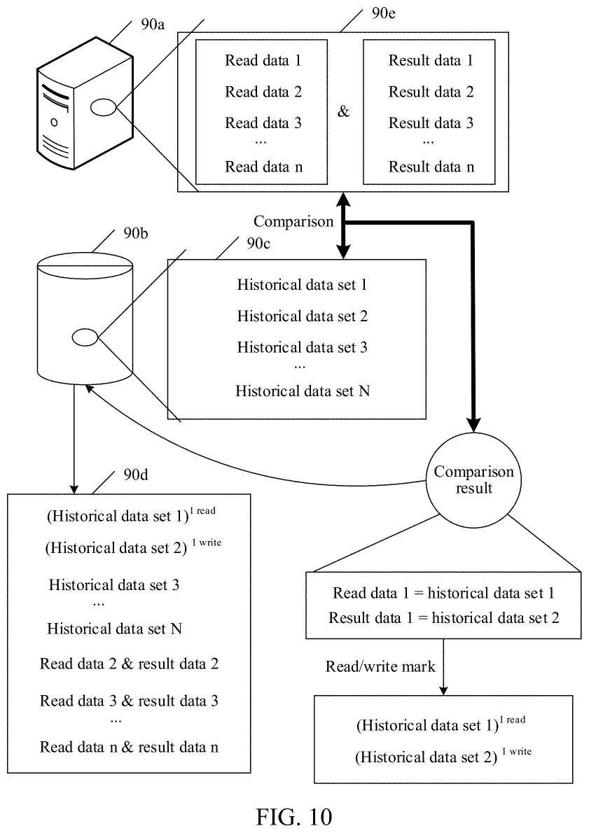

An embodiment of this application provides a general data synchronization method. The data synchronization method needs to process a contract, but does not change a nature that any logic can be implemented in the contract. The full node stores read data or/and result data in a database. Referring to FIG. 10 together, FIG. 10 is a schematic diagram of a target data storage scenario according to an embodiment of this application. As shown in FIG. 10, a to-be-stored data set 90e in a full node 90a may include read data 1, read data 2, read data 3, . . . , and read data n; and result data 1, result data 2, result data 3, . . . , and result data n. It is assumed that read data 1 is historical transaction data of transaction 1, and result data 1 is a transaction execution result of transaction 1; read data 2 is historical transaction data of transaction 2, and result data 2 is a transaction execution result of transaction 2; read data 3 is historical transaction data of transaction 3, and result data 3 is a transaction execution result of transaction 3; and . . . , read data n is historical transaction data of transaction n, and result data n is a transaction execution result of transaction n.

Solution 1: Read data 1 & result data 1 & transaction 1, read data 2 & result data 2 & transaction 2, read data 3 & result data 3 & transaction 3, . . . , and read data n & result data n & transaction n are separately associatively stored in the database 90b.

Solution 2: Data capacity comparison is performed between read data 1 and result data 1, and if a data capacity of read data 1 is less than a data capacity of result data 1, read data 1 & transaction 1 are associatively stored in the database 90b; and if the data capacity of read data 1 is equal to or greater than the data capacity of result data 1, result data 1 & transaction 1 are associatively stored in the database 90b. A target data set of another transaction is also similarly generated, and details are not described herein again.

Solution 3: Referring to FIG. 10 again, the full node 90a compares a to-be-stored data set 90e with a historical data set 90c in the database 90b, and stores the to-be-stored data set 90e according to a comparison result. The historical data set 90c includes a historical data set 1, a historical data set 2, a historical data set 3, . . . , and a historical data set N.

As shown in FIG. 10, in the comparison result, read data 1 is equivalent to the historical data set 1, and result data 1 is equivalent to the historical data set 2, marking the historical data set 1 to obtain (historical data set 1) “1 read”, where the read mark “1 read” may represent that the historical data set 1 is read data of transaction 1; and marking the historical data set 2 to obtain (historical data set 2) “1 write”, where the write mark “1 write” may represent that the historical data set 2 is result data of transaction 1.

Because other data in the to-be-stored data set 90e is different from the historical data set, the other data needs to be stored in the database 90b. As shown in FIG. 10, a new historical data set 90d includes a historical data set 1 that carries a read mark for transaction 1, a historical data set 2 that carries a write mark for transaction 1, a historical data set 3, . . . , historical data set N, read data 2 & result data 2, read data 3 & result data 3, . . . , and read data n & result data n.

Solution 4: A target data set is randomly determined, and if read data is determined as a target data set, the read data and the transaction detail data are associatively stored in a database; and if result data is determined as the target data set, the result data and the transaction detail data are associatively stored in the database.

It may be understood that, in actual application, the foregoing four solutions may be further mixed to generate a new solution, which is not limited herein.

Step 3: Parse a smart contract and method called in the transaction.

Step 4: Determine data that needs to be obtained by the light node.

Step 5: Return a result, including the transaction and data.

Step 6: Receive the transaction and data, and execute the smart contract as required.

Step 7: Verify whether the result is consistent with a proof.

Step 8: Save the transaction and execution result.

For the foregoing step 3 to step 8, refer to the embodiments respectively corresponding to FIG. 2 and FIG. 7. Details are not described herein again.

In this embodiment of this application, when a data synchronization request transmitted by the light node for a block is obtained, the entire synchronization block is not transmitted to the light node in this application. The synchronization transaction data is first obtained, the target data set and the verification data for the synchronization transaction data are then obtained, and the synchronization transaction data, the verification data, and the target data set are transmitted to the light node, so that the light node can execute a smart contract in a case in which only a part of data (not the entire synchronization block) is owned, perform a service logical operation on the data, and process a complex service. In the foregoing process, all nodes (including the light node and the full node) whose data are not equal to each other may execute a contract, so that a capability of a smart contract is fully utilized while data privacy protection is implemented, thereby determining accuracy of the data. In addition, because the target data set includes the read data or the result data that is obtained when the contract information is used for processing the transaction detail data, the light node may accurately obtain the to-be-verified result data of the transaction detail data by using the target data set. Based on the verification data, the light node may have permission to self-verify the synchronization transaction data and validity of the to-be-verified result data. With the permission, the light node may improve accuracy of verifying validity of the synchronization transaction data and the to-be-verified result data.

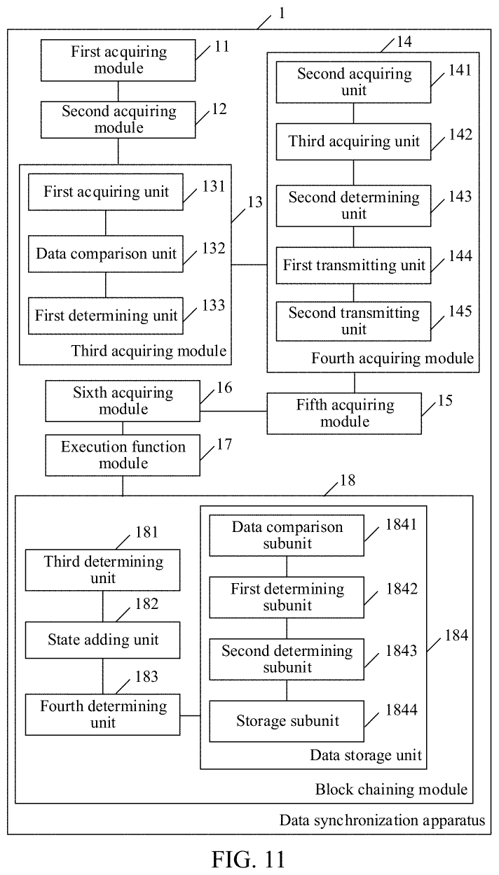

Further, FIG. 11 is a schematic structural diagram of a data synchronization apparatus according to an embodiment of this application. The foregoing data synchronization apparatus may be a computer program (including program code) running in a computer device. For example, the data synchronization apparatus is application software. The apparatus may be configured to perform corresponding steps in the method provided in the embodiments of this application. As shown in FIG. 11, the data synchronization apparatus 1 may include a first acquiring module 11, a second acquiring module 12, a third acquiring module 13, and a fourth acquiring module 14.

The first acquiring module 11 is configured to acquire a data synchronization request transmitted by a light node, the data synchronization request includes a block identifier of a synchronization block requested by the light node;

the second obtaining module 12 is configured to acquire synchronization transaction data in the synchronization block according to the block identifier; the synchronization transaction data includes transaction detail data and contract information of a smart contract used for processing the transaction detail data;

the third acquiring module 13 is configured to acquire, from a database, a target data set corresponding to the synchronization transaction data; the target data set includes read data or result data obtained in accordance with a determination that the transaction detail data is processed based on the contract information; and

the fourth acquiring module 14 is configured to: acquire, from the synchronization block, verification data corresponding to the synchronization transaction data, and transmit the synchronization transaction data, the verification data, and the target data set to the light node, so that the light node verifies, according to the verification data and the target data set, validity of the synchronization transaction data and to-be-verified result data corresponding to the transaction detail data.

For specific function implementations of the first acquiring module 11, the second acquiring module 12, the third acquiring module 13, and the fourth acquiring module 14, refer to step S101 to step S104 in the foregoing embodiment corresponding to FIG. 2. Details are not described herein again.

Referring to FIG. 11 again, the third acquiring module 13 may include a first acquiring unit 131, a data comparison unit 132, and a first determining unit 133.

The first acquiring unit 131 is configured to acquire, from the database, the target data set corresponding to the synchronization transaction data; the candidate data set including read data and result data;

the data comparison unit 132 is configured to compare a data capacity of the read data with a data capacity of the result data;

the first determining unit 133 is configured to: determine the read data as the target data set in accordance with a determination that the data capacity of the read data is less than the data capacity of the result data; and

the first determining unit 133 is further configured to: determine the result data as the target data set in accordance with a determination that the data capacity of the read data is equal to or greater than the data capacity of the result data.

For specific function implementations of the first acquiring unit 131, the data comparison unit 132, and the first determining unit 133, refer to step S103 in the embodiment corresponding to FIG. 2. Details are not described herein again.

Referring to FIG. 11 again, the verification data includes transaction verification data and result verification data; and

the fourth acquiring module 14 may include a second acquiring unit 141 and a third acquiring unit 142.

The second acquiring unit 141 is configured to acquire a transaction state tree and a result state tree from the synchronization block; the transaction state tree is a transaction hash tree generated based on the transaction detail data; the result state tree is a result hash tree generated based on the result data;

the third acquiring unit 142 is configured to acquire the transaction verification data from the transaction state tree based on the transaction detail data; and

the third acquiring unit 142 is further configured to acquire the result verification data from the result state tree based on the result data.

For specific function implementations of the second acquiring unit 141 and the third acquiring unit 142, refer to step S104 in the embodiment corresponding to FIG. 2. Details are not described herein again.

Referring to FIG. 11 again, the data synchronization request further includes a node identifier of the light node; and

the fourth acquiring module 14 may include a second determining unit 143, a first transmitting unit 144, and a second transmitting unit 145.

The second determining unit 143 is configured to determine a synchronization permission of the light node for the synchronization transaction data according to the node identifier; the synchronization permission includes a synchronization valid permission and a synchronization invalid permission;

the first transmitting unit 144 is configured to: a first transmitting unit, configured to: transmit data synchronization failure information to the light node in accordance with a determination that the synchronization permission of the light node for the synchronization transaction data is the synchronization invalid permission; and

the second transmitting unit 145 is configured to: transmit the synchronization transaction data, the verification data, and the target data set to the light node in accordance with a determination that the synchronization permission of the light node for the synchronization transaction data is the synchronization valid permission.

For specific function implementations of the second determining unit 143, the first transmitting unit 144, and the second transmitting unit 145, refer to step S104 in the embodiment corresponding to FIG. 2. Details are not described herein again.

Referring to FIG. 11 again, the data synchronization apparatus 1 may further include a fifth acquiring module 15, a sixth acquiring module 16, an execution function module 17, and a block chaining module 18.

The fifth acquiring module 15 is configured to acquire the transaction detail data in a to-be-chained block, and call a transaction execution function in the smart contract used for processing the transaction detail data;

the sixth acquiring module 16 is configured to acquire historical transaction data for the transaction detail data according to the transaction execution function, and determine the historical transaction data as the read data;

the execution function module 17 is configured to execute the transaction execution function according to the historical transaction data and the transaction detail data, to obtain a transaction execution result of the transaction detail data; and

the block chaining module 18 is configured to perform chaining processing on the to-be-chained block according to the transaction detail data and the transaction execution result.

For specific function implementations of the fifth acquiring module 15, the sixth acquiring module 16, the execution function module 17, and the block chaining module 18, refer to step S101 in the foregoing embodiment corresponding to FIG. 2. Details are not described herein again.

Referring to FIG. 11 again, the block chaining module 18 may include a third determining unit 181, a state adding unit 182, a fourth determining unit 183, and a data storage unit 184.

The third determining unit 181 is configured to: generate the result data according to the transaction execution result in accordance with a determination that the transaction detail data and the transaction execution result both pass consensus verification;

the state adding unit 182 is configured to: generate a transaction state tree according to the transaction detail data, generate a result state tree according to the result data, and add the transaction state tree and the result state tree to the to-be-chained block;

the fourth determining unit 183 is configured to: determine the to-be-chained block added with the transaction state tree and the result state tree as the synchronization block, and add the synchronization block to a blockchain; and

the data storage unit 184 is configured to generate the target data set according to the read data and the result data, and store the target data set in the database.

For specific function implementations of the third determining unit 181, the state adding unit 182, the fourth determining unit 183, and the data storage unit 184, refer to step S101 in the foregoing embodiment corresponding to FIG. 2. Details are not described herein again.

Referring to FIG. 11 again, the data storage unit 184 is specifically configured to: associatively store the read data with the transaction detail data in the database in accordance with a determination that the read data is determined as the target data set; and

the data storage unit 184 is further specifically configured to: associatively store the result data with the transaction detail data in the database in accordance with a determination that the result data is determined as the target data set.

For a specific function implementation of the data storage unit 184, refer to step S101 in the embodiment corresponding to FIG. 2. Details are not described herein again.

Referring to FIG. 11 again, the data storage unit 184 may include a data comparison subunit 1841, a first determining subunit 1842, a second determining subunit 1843, and a storage subunit 1844.

The data comparison subunit 1841 is configured to separately compare the read data and the result data with a historical data set; the historical data set including historical read data or historical result data that is in the database and that is corresponding to historical transaction detail data;

the first determining subunit 1842 is configured to: perform, in accordance with a determination that a historical data set matching the read data exists and a historical data set matching the result data exists, marking the historical data set matching the read data with a read mark, determine a historical data set that carries a read mark as a first data set, perform marking the historical data set matching the result data with a write mark, determine a historical data set that carries a write mark as a second data set, and determine the first data set and the second data set as the target data set;

the second determining subunit 1843 is configured to: determine the read data and the result data as the target data set in accordance with a determination that no historical data set matching the read data exists and no historical data set matching the result data exists; and

the storage subunit 1844 is configured to associatively store the target data set and the transaction detail data in the database.

For specific function implementations of the data comparison subunit 1841, the first determining subunit 1842, the second determining subunit 1843, and the storage subunit 1844, refer to step S101 in the foregoing embodiment corresponding to FIG. 2. Details are not described herein again.

In this embodiment of this application, when a data synchronization request transmitted by the light node for a block is obtained, the entire synchronization block is not transmitted to the light node in this application. The synchronization transaction data is first obtained, the target data set and the verification data for the synchronization transaction data are then obtained, and the synchronization transaction data, the verification data, and the target data set are transmitted to the light node, so that the light node can execute a smart contract in a case in which only a part of data (not the entire synchronization block) is owned, perform a service logical operation on the data, and process a complex service. In the foregoing process, all nodes (including the light node and the full node) whose data are not equal to each other may execute a contract, so that a capability of a smart contract is fully utilized while data privacy protection is implemented, thereby determining accuracy of the data. In addition, because the target data set includes the read data or the result data that is obtained when the contract information is used for processing the transaction detail data, the light node may accurately obtain the to-be-verified result data of the transaction detail data by using the target data set. Based on the verification data, the light node may have permission to self-verify the synchronization transaction data and validity of the to-be-verified result data. With the permission, the light node may improve accuracy of verifying validity of the synchronization transaction data and the to-be-verified result data.

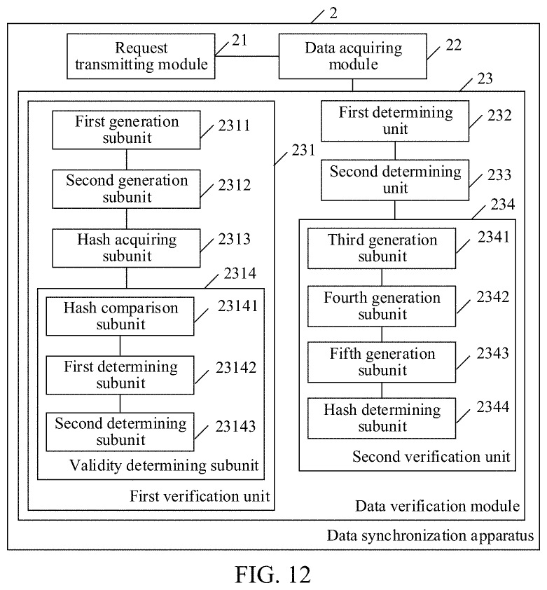

Further, FIG. 12 is a schematic structural diagram of a data synchronization apparatus according to an embodiment of this application. The foregoing data synchronization apparatus may be a computer program (including program code) running in a computer device. For example, the data synchronization apparatus is application software. The apparatus may be configured to perform corresponding steps in the method provided in the embodiments of this application. As shown in FIG. 12, the data synchronization apparatus 2 may include a request transmitting module 21, a data acquiring module 22, and a data verification module 23.

The request transmitting module 21 is configured to transmit a data synchronization request that carries a block identifier to a full node, so that the full node acquires synchronization transaction data in a synchronization block according to the block identifier, acquires a target data set corresponding to the synchronization transaction data from a database, and acquires verification data corresponding to the synchronization transaction data from the synchronization block; the block identifier being used for representing an identifier of the requested synchronization block; the synchronization transaction data including transaction detail data and contract information of a smart contract used by the full node to process the transaction detail data; and the target data set including read data or result data obtained by the full node in a case of processing the transaction detail data based on the contract information.

The data acquiring module 22 is configured to acquire the synchronization transaction data, the verification data, and the target data set that are transmitted by the full node; and

the data verification module 23 is configured to verify, according to the verification data and the target data set, validity of the synchronization transaction data and to-be-verified result data corresponding to the transaction detail data.

For specific function implementations of the request transmitting module 21, the data acquiring module 22, and the data verification module 23, refer to step S201 to step S203 in the embodiment corresponding to FIG. 7. Details are not described herein again.

Referring to FIG. 12 again, the data verification module 23 may include a first verification unit 231, a first determining unit 232, a second determining unit 233, and a second verification unit 234.

The first verification unit 231 is configured to: determine the result data as the to-be-verified result data corresponding to the transaction detail data in accordance with a determination that the target data set is the result data; obtain a first to-be-verified root hash according to the transaction detail data, the to-be-verified result data, and the verification data; and verify validity of the synchronization transaction data and the to-be-verified result data according to the first to-be-verified root hash;

the first determining unit 232 is configured to: determine the smart contract of the transaction detail data according to a contract name in the contract information in accordance with a determination that the target data set is the read data;

the second determining unit 233 is configured to determine, according to a function name in the contract information, a transaction execution function called by the smart contract to process the transaction detail data; and

the second verification unit 234 is configured to: obtain a second to-be-verified root hash according to the read data, the transaction execution function, the transaction detail data, and the verification data, and verify validity of the synchronization transaction data and the to-be-verified result data according to the second to-be-verified root hash.

For specific function implementations of the first verification unit 231, the first determining unit 232, the second determining unit 233, and the second verification unit 234, refer to step S203 in the foregoing embodiment corresponding to FIG. 7. Details are not described herein again.

Referring to FIG. 12 again, the verification data includes transaction verification data and result verification data; the first to-be-verified root hash includes a to-be-verified transaction root hash and a to-be-verified result root hash; and

the first verification unit 231 may include a first generation subunit 2311, a second generation subunit 2312, a hash acquiring subunit 2313, and a validity determining subunit 2314.

The first generation subunit 2311 is configured to obtain the to-be-verified transaction root hash according to the transaction detail data and the transaction verification data;

the second generation subunit 2312 is configured to obtain the to-be-verified result root hash according to the to-be-verified result data and the result verification data;

the hash acquiring subunit 2313 is configured to acquire a block header for the synchronization block, and acquire a verified transaction root hash and a verified result root hash from the block header; and

the validity determining subunit 2314 is configured to determine validity of the synchronization transaction data and the to-be-verified result data according to the to-be-verified transaction root hash, the to-be-verified result root hash, the verified transaction root hash, and the verified result root hash.

For specific function implementations of the first generation subunit 2311, the second generation subunit 2312, the hash acquiring subunit 2313, and the validity determining subunit 2314, refer to step S203 in the foregoing embodiment corresponding to FIG. 7. Details are not described herein again.

Referring to FIG. 12 again, the validity determining subunit 2314 may include a hash comparison subunit 23141, a first determining subunit 23142, and a second determining subunit 23143.

The hash comparison subunit 23141 is configured to compare the to-be-verified transaction root hash with the verified transaction root hash, and compare the to-be-verified result root hash with the verified result root hash;

the first determining subunit 23142 is configured to: in accordance with a determination that the to-be-verified transaction root hash is different from the verified transaction root hash, determine that the synchronization transaction data is invalid data, and accordance with a determination that the to-be-verified transaction root hash is the same as the verified transaction root hash, determine that the synchronization transaction data is valid data;

the second determining subunit 23143 is configured to: in accordance with a determination that the to-be-verified result root hash is different from the verified result root hash, determine that the to-be-verified result data is invalid data, and in case that the to-be-verified result root hash is the same as the verified result root hash, determine that the to-be-verified result data is valid data; and

the second determining subunit 23143 is further configured to: when the synchronization transaction data is valid data and the to-be-verified result data is valid data, associatively store the to-be-verified result data and the synchronization transaction data.

For specific function implementations of the hash comparison subunit 23141, the first determining subunit 23142, and the second determining subunit 23143, refer to step S203 in the foregoing embodiment corresponding to FIG. 7. Details are not described herein again.

Referring to FIG. 12 again, the verification data includes transaction verification data and result verification data; and

the second verification unit 234 may include a third generation subunit 2341, a fourth generation subunit 2342, a fifth generation subunit 2343, and a determining hash subunit 2344.

The third generation subunit 2341 is configured to input the read data and the transaction detail data into the transaction execution function to obtain a to-be-verified transaction execution result of the transaction detail data, and generate the to-be-verified result data according to the to-be-verified transaction execution result;

the fourth generation subunit 2342 is configured to obtain the to-be-verified result root hash according to the to-be-verified result data and the result verification data;

the fifth generation subunit 2343 is configured to obtain a to-be-verified transaction root hash according to the transaction detail data and the transaction verification data; and

the hash determining subunit 2344 is configured to determine the to-be-verified result root hash and the to-be-verified transaction root hash as the second to-be-verified root hash.

For specific function implementations of the third generation subunit 2341, the fourth generation subunit 2342, the fifth generation subunit 2343, and the hash determining subunit 2344, refer to step S203 in the foregoing embodiment corresponding to FIG. 7. Details are not described herein again.

In this embodiment of this application, when a data synchronization request transmitted by the light node for a block is obtained, the entire synchronization block is not transmitted to the light node in this application. The synchronization transaction data is first obtained, the target data set and the verification data for the synchronization transaction data are then obtained, and the synchronization transaction data, the verification data, and the target data set are transmitted to the light node, so that the light node can execute a smart contract in a case in which only a part of data (not the entire synchronization block) is owned, perform a service logical operation on the data, and process a complex service. In the foregoing process, all nodes (including the light node and the full node) whose data are not equal to each other may execute a contract, so that a capability of a smart contract is fully utilized while data privacy protection is implemented, thereby determining accuracy of the data. In addition, because the target data set includes the read data or the result data that is obtained when the contract information is used for processing the transaction detail data, the light node may accurately obtain the to-be-verified result data of the transaction detail data by using the target data set. Based on the verification data, the light node may have permission to self-verify the synchronization transaction data and validity of the to-be-verified result data. With the permission, the light node may improve accuracy of verifying validity of the synchronization transaction data and the to-be-verified result data.

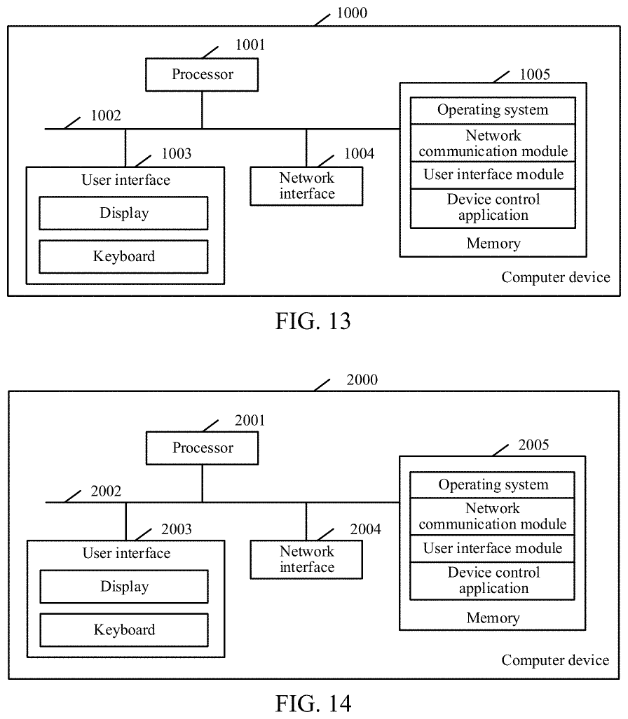

Further, FIG. 13 is a schematic structural diagram of a computer device according to an embodiment of this application. As shown in FIG. 13, the computer device 1000 may be the full node in the foregoing embodiment corresponding to FIG. 2. The computer device 1000 may include at least one processor 1001, such as a CPU, at least one network interface 1004, a user interface 1003, a memory 1005, and at least one communication bus 1002. The communication bus 1002 is configured to implement connection and communication between these components. The user interface 1003 may include a display, a keyboard, and in some embodiments, the network interface 1004 may include a standard wired interface and a standard wireless interface (for example, a WI-FI interface). The memory 1005 may be a high-speed RAM, or may be a non-volatile memory, for example, at least one magnetic disk memory. In some embodiments, the memory 1005 may be at least one storage apparatus located remotely from the foregoing processor 1001. As shown in FIG. 13, the memory 1005 used as a computer storage medium may include an operating system, a network communication module, a user interface module, and a device-control application program.

In the computer device 1000 shown in FIG. 13, the network interface 1004 may provide a network communication function, the user interface 1003 is mainly configured to provide an input interface for a user, and the processor 1001 may be configured to invoke the device-control application stored in the memory 1005, to implement:

acquiring a data synchronization request transmitted by a light node; the data synchronization request including a block identifier of a synchronization block requested by the light node;

acquiring synchronization transaction data in the synchronization block according to the block identifier; the synchronization transaction data including transaction detail data and contract information of a smart contract used for processing the transaction detail data;

acquiring, from a database, a target data set corresponding to the synchronization transaction data; the target data set including read data or result data obtained in accordance with a determination that the transaction detail data is processed based on the contract information; and

acquiring, from the synchronization block, verification data corresponding to the synchronization transaction data, and transmitting the synchronization transaction data, the verification data, and the target data set to the light node, so that the light node verifies, according to the verification data and the target data set, validity of the synchronization transaction data and to-be-verified result data corresponding to the transaction detail data.

It is to be understood that the computer device 1000 described in this embodiment of this application can perform the data synchronization methods in the foregoing embodiments corresponding to FIG. 2, FIG. 5, FIG. 7, and FIG. 9, and can also perform steps performed by the data synchronization apparatus 1 in the foregoing embodiment corresponding to FIG. 11. Details are not repeated herein. In addition, beneficial effects achieved by using the same method are not described herein again.

Further, FIG. 14 is a schematic structural diagram of a computer device according to an embodiment of this application. As shown in FIG. 14, the computer device 2000 may be a light node in an embodiment corresponding to FIG. 7. The computer device 2000 may include: a processor 2001, a network interface 2004, and a memory 2005, as well as a user interface 2003 and at least one communication bus 2002. The communication bus 2002 is configured to implement connection and communication between these components. The user interface 2003 may include a display and a keyboard. In some embodiments, the user interface 2003 may further include a standard wired interface and a standard wireless interface. In some embodiments, the network interface 2004 may include a standard wired interface and a standard wireless interface (such as a Wi-Fi interface). The memory 2005 may be a high-speed random access memory (RAM), or may be a non-volatile memory, for example, at least one magnetic disk storage. In some embodiments, the memory 2005 may be at least one storage apparatus that is located far away from the foregoing processor 2001. As shown in FIG. 14, the memory 2005 used as a computer-readable storage medium may include an operating system, a network communication module, a user interface module, and a device-control application program.

In the computer device 2000 shown in FIG. 14, the network interface 2004 may provide a network communication function, the user interface 2003 is mainly configured to provide an input interface for a user, and the processor 2001 may be configured to invoke the device-control application stored in the memory 2005, to implement:

transmitting a data synchronization request that carries a block identifier to a full node, so that the full node acquires synchronization transaction data in a synchronization block according to the block identifier, acquires a target data set corresponding to the synchronization transaction data from a database, and acquires verification data corresponding to the synchronization transaction data from the synchronization block; the block identifier being used for representing an identifier of the requested synchronization block; the synchronization transaction data including transaction detail data and contract information of a smart contract used by the full node to process the transaction detail data; the target data set including read data or result data obtained by the full node in a case of processing the transaction detail data based on the contract information;

acquiring the synchronization transaction data, the verification data, and the target data set that are transmitted by the full node; and

verifying, according to the verification data and the target data set, validity of the synchronization transaction data and to-be-verified result data corresponding to the transaction detail data.

It is to be understood that the computer device 2000 described in this embodiment of this application can perform the data synchronization methods in the foregoing embodiments corresponding to FIG. 2, FIG. 5, FIG. 7, and FIG. 9, and can also perform steps performed by the data synchronization apparatus 2 in the foregoing embodiment corresponding to FIG. 12. Details are not repeated herein. In addition, beneficial effects achieved by using the same method are not described herein again.

An embodiment of this application further provides a computer readable storage medium. The computer readable storage medium stores a computer program. The computer program includes program instructions. When being executed by a processor, the program instructions implement the data synchronization method provided in steps in FIG. 2, FIG. 5, FIG. 7, and FIG. 9. For details, refer to the foregoing implementations provided in steps in FIG. 2, FIG. 5, FIG. 7, and FIG. 9. Details are not described herein again. In addition, beneficial effects achieved by using the same method are not described herein again.

The computer-readable storage medium may be the data synchronization apparatus provided in any of the foregoing embodiments or an internal storage unit of the computer device, for example, a hard disk or an internal memory of the computer device. The computer-readable storage medium may also be an external storage device of the computer device, such as a plug-in hard disk, a smart media card (SMC), a secure digital (SD) card, or a flash card that is equipped on the computer device. Further, the computer-readable storage medium may also include an internal storage unit of the computer device and an external storage device. The computer-readable storage medium is configured to store the computer program and another program and data that are required by the computer device. The computer-readable storage medium may be further configured to temporarily store data that has been outputted or data to be outputted.

According to an aspect of this application, a computer program product or a computer program is provided, including computer instructions, the computer instructions being stored in a computer-readable storage medium. A processor of a computer device reads the computer instructions from the computer-readable storage medium, and executes the computer instructions, to cause the computer device to perform descriptions of the data synchronization method shown in embodiments corresponding to FIG. 2, FIG. 5, FIG. 7, and FIG. 9. Details are not described herein. In addition, beneficial effects achieved by using the same method are not described herein again.

In the specification, claims, and accompanying drawings of the embodiments of this application, the terms “first”, “second”, or the like are intended to distinguish between different objects but do not indicate a particular order. In addition, the terms “include” and any variant thereof are intended to cover a non-exclusive inclusion. For example, a process, method, apparatus, product, or device that includes a series of steps or modules is not limited to the listed steps or modules; and instead, further includes a step or module that is not listed in some embodiments, or further includes another step or unit that is intrinsic to the process, method, apparatus, product, or device, in some embodiments.

A person of ordinary skill in the art may be aware that the units and algorithm steps in the examples described with reference to the embodiments disclosed herein may be implemented by electronic hardware, computer software, or a combination thereof. To clearly describe the interchangeability between the hardware and the software, the foregoing has generally described compositions and steps of each example according to functions. Whether the functions are executed by hardware or software depends on particular applications and design constraint conditions of the technical solutions. A person skilled in the art may use different methods to implement the described functions for each particular application, but it is not to be considered that the implementation goes beyond the scope of this application.

The methods and related apparatuses provided by the embodiments of this application are described with reference to the method flowcharts and/or schematic structural diagrams provided in the embodiments of this application. Specifically, each process of the method flowcharts and/or each block of the schematic structural diagrams, and a combination of processes in the flowcharts and/or blocks in the block diagrams can be implemented by computer program instructions. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the schematic structural diagrams. These computer program instructions may also be stored in a computer-readable memory that can guide a computer or another programmable data processing device to work in a specified manner, so that the instructions stored in the computer-readable memory generate a product including an instruction apparatus, where the instruction apparatus implements functions specified in one or more processes in the flowcharts and/or one or more blocks in the schematic structural diagrams. The computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagrams.

In sum, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data synchronization method, comprising:
receiving a data synchronization request from a light node, the data synchronization request comprising a block identifier of a synchronization block requested by the light node;
obtaining synchronization transaction data in the synchronization block according to the block identifier, the synchronization transaction data comprising transaction detail data and contract information of a smart contract used for processing the transaction detail data;
obtaining, from a database, a target data set corresponding to the synchronization transaction data, the target data set comprising read data or result data, wherein the result data is obtained by processing the transaction detail data based on the contract information; and
obtaining, from the synchronization block, verification data corresponding to the synchronization transaction data;
transmitting the synchronization transaction data, the verification data, and the target data set to the light node; and
verifying, by the light node, a validity of the synchronization transaction data and to-be-verified result data corresponding to the transaction detail data, based on the verification data and the target data set.

2. The method according to claim 1, wherein obtaining, from a database, a target data set corresponding to the synchronization transaction data comprises:
obtaining, from the database, a candidate data set corresponding to the synchronization transaction data, the candidate data set comprising the read data and the result data;
in accordance with a determination that a data capacity of the read data is less than a data capacity of the result data, setting the read data as the target data set; and
in accordance with a determination that the data capacity of the read data is equal to or greater than the data capacity of the result data, setting the result data as the target data set.

3. The method according to claim 1, wherein the verification data comprises transaction verification data and result verification data; and
obtaining, from the synchronization block, verification data corresponding to the synchronization transaction data comprises:
obtaining a transaction state tree and a result state tree from the synchronization block, the transaction state tree being a transaction hash tree generated based on the transaction detail data, and the result state tree being a result hash tree generated based on the result data;
obtaining the transaction verification data from the transaction state tree based on the transaction detail data; and
obtaining the result verification data from the result state tree based on the result data.

4. The method according to claim 1, wherein the data synchronization request further comprises a node identifier of the light node; and
transmitting the synchronization transaction data, the verification data, and the target data set to the light node comprises:
determining a synchronization permission of the light node for the synchronization transaction data according to the node identifier, the synchronization permission comprising a synchronization valid permission and a synchronization invalid permission;
in accordance with a determination that the synchronization permission of the light node for the synchronization transaction data is the synchronization invalid permission, transmitting data synchronization failure information to the light node; and
in accordance with a determination that the synchronization permission of the light node for the synchronization transaction data is the synchronization valid permission, transmitting the synchronization transaction data, the verification data, and the target data set to the light node.

5. The method according to claim 1, further comprising:
obtaining the transaction detail data in a to-be-chained block, and executing a transaction execution function in the smart contract used for processing the transaction detail data;
obtaining historical transaction data for the transaction detail data according to the transaction execution function, and setting the historical transaction data as the read data;
executing the transaction execution function according to the historical transaction data and the transaction detail data to obtain a transaction execution result of the transaction detail data; and
performing chaining processing on the to-be-chained block according to the transaction detail data and the transaction execution result.

6. The method according to claim 5, wherein performing chaining processing on the to-be-chained block comprises:
in accordance with a determination that the transaction detail data and the transaction execution result both pass consensus verification, generating the result data according to the transaction execution result;
generating a transaction state tree according to the transaction detail data, generating a result state tree according to the result data, and adding the transaction state tree and the result state tree to the to-be-chained block;
setting the to-be-chained block added with the transaction state tree and the result state tree as the synchronization block, and adding the synchronization block to a blockchain; and
generating the target data set according to the read data and the result data, and storing the target data set in the database.

7. The method according to claim 6, wherein generating the target data set according to the read data and the result data, and storing the target data set in the database comprises:
in accordance with a determination that the read data is set as the target data set, associatively storing the read data with the transaction detail data in the database; and
in accordance with a determination that the result data is set as the target data set, associatively storing the result data with the transaction detail data in the database.

8. The method according to claim 6, wherein generating the target data set according to the read data and the result data, and storing the target data set in the database comprises:
comparing the read data with a historical data set comprising historical read data or historical result data in the database, the historical data set corresponding to historical transaction detail data;
comparing the result data with the historical data set;
in accordance with a determination that a historical data set matches the read data and a historical data set matches the result data, marking the historical data set that matches the read data with a read mark, setting a historical data set that carries a read mark as a first data set, marking the historical data set that matches the result data with a write mark, setting a historical data set having a write mark as a second data set, and setting the first data set and the second data set as the target data set;
in accordance with a determination that no historical data set matches the read data and no historical data set matches the result data, setting the read data and the result data as the target data set; and
associatively storing the target data set and the transaction detail data in the database.

9. An electronic device, comprising:
one or more processors; and
memory storing one or more programs, the one or more programs comprising instructions that, when executed by the one or more processors, cause the one or more processors to perform operations comprising:
receiving a data synchronization request from a light node, the data synchronization request comprising a block identifier of a synchronization block requested by the light node;
obtaining synchronization transaction data in the synchronization block according to the block identifier, the synchronization transaction data comprising transaction detail data and contract information of a smart contract used for processing the transaction detail data;
obtaining, from a database, a target data set corresponding to the synchronization transaction data, the target data set comprising read data or result data, wherein the result data is obtained by processing the transaction detail data based on the contract information; and
obtaining, from the synchronization block, verification data corresponding to the synchronization transaction data;
transmitting the synchronization transaction data, the verification data, and the target data set to the light node; and
verifying, by the light node, a validity of the synchronization transaction data and to-be-verified result data corresponding to the transaction detail data, based on the verification data and the target data set.

10. The electronic device of claim 9, wherein obtaining, from a database, a target data set corresponding to the synchronization transaction data comprises:
obtaining, from the database, a candidate data set corresponding to the synchronization transaction data, the candidate data set comprising the read data and the result data;
in accordance with a determination that a data capacity of the read data is less than a data capacity of the result data, setting the read data as the target data set; and
in accordance with a determination that the data capacity of the read data is equal to or greater than the data capacity of the result data, setting the result data as the target data set.

11. The electronic device of claim 9, wherein the verification data comprises transaction verification data and result verification data; and
obtaining, from the synchronization block, verification data corresponding to the synchronization transaction data comprises:
obtaining a transaction state tree and a result state tree from the synchronization block, the transaction state tree being a transaction hash tree generated based on the transaction detail data, and the result state tree being a result hash tree generated based on the result data;
obtaining the transaction verification data from the transaction state tree based on the transaction detail data; and
obtaining the result verification data from the result state tree based on the result data.

12. The electronic device of claim 9, wherein the one or more programs comprising the instructions that, when executed by the one or more processors, cause the one or more processors to perform operations further comprising:
obtaining the transaction detail data in a to-be-chained block, and executing a transaction execution function in the smart contract used for processing the transaction detail data;
obtaining historical transaction data for the transaction detail data according to the transaction execution function, and setting the historical transaction data as the read data;
executing the transaction execution function according to the historical transaction data and the transaction detail data to obtain a transaction execution result of the transaction detail data; and
performing chaining processing on the to-be-chained block according to the transaction detail data and the transaction execution result,

13. The electronic device of claim 12, wherein performing chaining processing on the to-be-chained block comprises:
in accordance with a determination that the transaction detail data and the transaction execution result both pass consensus verification, generating the result data according to the transaction execution result;
generating a transaction state tree according to the transaction detail data, generating a result state tree according to the result data, and adding the transaction state tree and the result state tree to the to-be-chained block;
setting the to-be-chained block added with the transaction state tree and the result state tree as the synchronization block, and adding the synchronization block to a blockchain; and
generating the target data set according to the read data and the result data, and storing the target data set in the database.

14. The electronic device of claim 13, wherein generating the target data set according to the read data and the result data, and storing the target data set in the database comprises:
in accordance with a determination that the read data is set as the target data set, associatively storing the read data with the transaction detail data in the database; and
in accordance with a determination that the result data is set as the target data set, associatively storing the result data with the transaction detail data in the database.

15. A non-transitory computer-readable storage medium, storing a computer program, the computer program, when executed by one or more processors of an electronic device, cause the one or more processors to perform operations comprising:
receiving a data synchronization request from a light node, the data synchronization request comprising a block identifier of a synchronization block requested by the light node;
obtaining synchronization transaction data in the synchronization block according to the block identifier, the synchronization transaction data comprising transaction detail data and contract information of a smart contract used for processing the transaction detail data;
obtaining, from a database, a target data set corresponding to the synchronization transaction data, the target data set comprising read data or result data, wherein the result data is obtained by processing the transaction detail data based on the contract information; and
obtaining, from the synchronization block, verification data corresponding to the synchronization transaction data;
transmitting the synchronization transaction data, the verification data, and the target data set to the light node; and
verifying, by the light node, a validity of the synchronization transaction data and to-be-verified result data corresponding to the transaction detail data, based on the verification data and the target data set.

16. The non-transitory computer-readable storage medium of claim 14, wherein obtaining, from a database, a target data set corresponding to the synchronization transaction data comprises:
obtaining, from the database, a candidate data set corresponding to the synchronization transaction data, the candidate data set comprising the read data and the result data;
in accordance with a determination that a data capacity of the read data is less than a data capacity of the result data, setting the read data as the target data set; and
in accordance with a determination that the data capacity of the read data is equal to or greater than the data capacity of the result data, setting the result data as the target data set.

17. The non-transitory computer-readable storage medium of claim 14, wherein the verification data comprises transaction verification data and result verification data; and
obtaining, from the synchronization block, verification data corresponding to the synchronization transaction data comprises:
obtaining a transaction state tree and a result state tree from the synchronization block, the transaction state tree being a transaction hash tree generated based on the transaction detail data, and the result state tree being a result hash tree generated based on the result data;
obtaining the transaction verification data from the transaction state tree based on the transaction detail data; and
obtaining the result verification data from the result state tree based on the result data.

18. The non-transitory computer-readable storage medium of claim 14, further comprising:
obtaining the transaction detail data in a to-be-chained block, and executing a transaction execution function in the smart contract used for processing the transaction detail data;
obtaining historical transaction data for the transaction detail data according to the transaction execution function, and setting the historical transaction data as the read data;
executing the transaction execution function according to the historical transaction data and the transaction detail data to obtain a transaction execution result of the transaction detail data; and
performing chaining processing on the to-be-chained block according to the transaction detail data and the transaction execution result,

19. The non-transitory computer-readable storage medium of claim 17, wherein performing chaining processing on the to-be-chained block comprises:
in accordance with a determination that the transaction detail data and the transaction execution result both pass consensus verification, generating the result data according to the transaction execution result;
generating a transaction state tree according to the transaction detail data, generating a result state tree according to the result data, and adding the transaction state tree and the result state tree to the to-be-chained block;
setting the to-be-chained block added with the transaction state tree and the result state tree as the synchronization block, and adding the synchronization block to a blockchain; and
generating the target data set according to the read data and the result data, and storing the target data set in the database.

20. The non-transitory computer-readable storage medium of claim 19, wherein generating the target data set according to the read data and the result data, and storing the target data set in the database comprises:
in accordance with a determination that the read data is set as the target data set, associatively storing the read data with the transaction detail data in the database; and
in accordance with a determination that the result data is set as the target data set, associatively storing the result data with the transaction detail data in the database.
